(19) United States
(12) Patent Application Publication
(10) Pub. No.: US 2015/0174803 A1
(43) Pub. Date: Jun. 25, 2015

(54) Methods of Forming Overmolded Articles

(71) Applicant: iMFLUX Inc., Cincinnati, OH (US)

(72) Inventors: Matthew Lloyd NEWMAN, Cincinnati, OH (US); John Moncrief LAYMAN, Liberty Twp., OH (US); Andrew Eric NELTNER, Loveland, OH (US); Randall Alan WATSON, Loveland, OH (US); Gene Michael ALTONEN, West Chester, OH (US)

(21) Appl. No.: 14/577,310

(22) Filed: Dec. 19, 2014

Related U.S. Application Data
(60) Provisional application No. 61/918,438, filed on Dec. 19, 2013.

(51) Int. Cl. B29C 45/14; B29D 22/00; B29D 1/00

(52) U.S. Cl. CPC B29C 45/14; B29D 1/00; B29D 22/003; B29K 2101/12

(57) ABSTRACT

A method for injection molding overmolded articles includes heating thermoplastic material to a predetermined temperature in an injection molding apparatus. The injection molding apparatus has a mold including a mold cavity. The injection molding apparatus has a useful life of more than about 1 million injection molding cycles and less than about 20 million injection molding cycles. The method further includes positioning a pre-manufactured article in the mold cavity, advancing heated thermoplastic material from the melt holder of the injection molding apparatus into the mold cavity maintaining a substantially constant melt pressure in the proximity of the injection element of at least about 400 pounds per square inch (about 2 MPa) and at most about 10,000 pounds per square inch (about 69 MPa).

### TECHNICAL FIELD OF THE INVENTION

The present disclosure relates to methods of forming injection molded articles, and, more particularly, to methods of forming overmolded articles at substantially constant low injection pressures.

### BACKGROUND OF THE INVENTION

Injection molded articles, such as consumer goods, electronics, containers, and the like can be made using a number of techniques, depending on the requirements of the injection molded article. Injection molded articles may be formed using multiple techniques if, for example, different materials are used or different functions are required of the final injection molded article. For example, components of electronic devices such as, for example, keypads and handheld scanners, may be made using an overmold injection molding process, or another manufacturing process. In some of these processes, the final injection molded article, or final product, may be formed by overmolding a base component. The base component may be pre-manufactured, for example. However, the base component may have certain temperature, pressure, or shear sensitive properties that may need to be considered when overmolding the base component. Accordingly, improved methods of forming overmolded articles are desired.

### SUMMARY OF THE INVENTION

In one embodiment, a method for injection molding overmolded articles. The method includes heating thermoplastic material to a predetermined temperature in an injection molding apparatus, wherein, the injection molding apparatus comprises a mold, a plastic melt injection system, a sensor, and a controller, the mold comprises a mold cavity, the plastic melt injection system comprises a melt holder and an injection element, and the injection molding apparatus has a useful life of more than 1 million and less than twenty million injection molding cycles. The method further includes positioning a pre-manufactured article in the mold cavity, advancing heated thermoplastic material from the melt holder of the injection molding apparatus into the mold cavity using the injection element, determining a melt pressure of the heated thermoplastic material as the heated thermoplastic material is advanced into the mold cavity using the sensor, sending a signal from the sensor to the controller, the signal indicating the melt pressure of the heated thermoplastic material, maintaining a substantially constant melt pressure of the thermoplastic material entering the mold cavity using the controller and the plastic melt injection system, wherein the melt pressure in the proximity of the injection element is from about 2 MPa (about 400 pounds per square inch) to about 69 MPa (about 10,000 pounds per square inch), and substantially filling the mold cavity with thermoplastic material such that the pre-manufactured article is in contact with the thermoplastic material.

In another embodiment, a method for injection molding overmolded articles with hollow bodies includes heating thermoplastic material to a predetermined temperature in an injection molding apparatus, wherein the injection molding apparatus comprises a mold, a plastic melt injection system, a sensor, and a controller, the mold comprises a mold cavity, the mold is comprised of a material having a thermal conductivity of between about 8 watts per meter Kelvin (about 5 BTUs/(hr-ft-° F.)) and about 385 watts per meter Kelvin (about 223 BTUs/(hr-ft-° F.)), the plastic melt injection system comprises a melt holder and an injection element, and the injection molding apparatus has a useful life of more than 1 million injection molding cycles. The method further includes positioning a partially hollow article in the mold cavity, the partially hollow article formed at least partially from a plastic material, advancing heated thermoplastic material from the melt holder of the injection molding apparatus into the mold cavity using the injection element such that the thermoplastic material contacts the partially hollow article, determining a melt pressure of the heated thermoplastic material as the heated thermoplastic material is advanced into the mold cavity using the sensor, sending a signal from the sensor to the controller, the signal indicating the melt pressure of the heated thermoplastic material, maintaining a substantially constant melt pressure of the thermoplastic material entering the mold cavity using the controller and the plastic melt injection system, wherein the melt pressure is from about 2 MPa (about 400 pounds per square inch) to about 69 MPa (about 10,000 pounds per square inch), and substantially filling the mold cavity with thermoplastic material such that the partially hollow article is in contact with the thermoplastic material.

In another embodiment, a method for injection molding an overmolded article includes heating a first thermoplastic material to a first temperature in an injection molding apparatus, heating a second thermoplastic material to a second temperature in the injection molding apparatus, wherein the injection molding apparatus comprises a mold, a plastic melt injection system, a sensor, and a controller, the mold comprises a mold cavity, the mold is comprised of a material having a thermal conductivity of between about 8 watts per meter Kelvin (about 5 BTUs/(hr-ft-° F.)) and about 385 watts per meter Kelvin (about 223 BTUs/(hr-ft-° F.)), the plastic melt injection system comprises a melt holder and an injection element, and the injection molding apparatus has a useful life from about 1 million injection molding cycles to about 20 million injection molding cycles. The method further includes advancing the first heated thermoplastic material from the melt holder of the injection molding apparatus into the mold cavity using the injection element, advancing the second heated thermoplastic material from the melt holder of the injection molding apparatus into the mold cavity using the injection element after the first heated thermoplastic material has been advanced, determining a melt pressure of the second heated thermoplastic material as the second heated thermoplastic material is advanced into the mold cavity using the sensor, sending a signal from the sensor to the controller, the signal indicating the melt pressure of the second heated thermoplastic material, and maintaining a substantially constant melt pressure of the second thermoplastic material entering the mold cavity using the controller and the plastic melt injection system, wherein the melt pressure is from about 2 MPa (about 400 pounds per square inch) to about 69 MPa (about 10,000 pounds per square inch), wherein the first thermoplastic material has a melt temperature that is lower than a melt temperature of the second thermoplastic material.

### BRIEF DESCRIPTION OF THE DRAWINGS

The embodiments set forth in the drawings are illustrative in nature and not intended to limit the subject matter defined by the claims. The following detailed description of the illustrative embodiments can be understood when read in conjunction with the following drawings, where like structure is indicated with like reference numerals and in which:

FIG. 1 illustrates a schematic view of one embodiment of a substantially constant low injection pressure molding machine constructed according to the disclosure;

FIG. 2 is a cavity pressure vs. time graph for the substantially constant low injection pressure molding machine of FIG. 1 superimposed over a cavity pressure vs. time graph for a conventional high variable pressure injection molding machine;

FIG. 3 is another cavity pressure vs. time graph for the substantially constant low injection pressure molding machine of FIG. 1 superimposed over a cavity pressure vs. time graph for a conventional high variable pressure injection molding machine, the graphs illustrating the percentage of fill time devoted to certain fill stages;

FIGS. 4A-4D are side cross-sectional views of a portion of a mold cavity in various stages of fill by a conventional high variable pressure injection molding machine;

FIGS. 5A-5D are side cross-sectional views of a portion of a pre-manufactured article secured in a mold cavity in various stages of fill by the substantially constant low injection pressure molding machine of FIG. 1;

FIGS. 6A-6D are schematic cross-sectional illustrations of a reverse overmolding cycle that may be carried out on a substantially constant low injection pressure molding machine as described herein;

FIGS. 7A-7G are schematic cross-sectional illustrations of one embodiment of a overmolded article created using a substantially constant low injection pressure molding machine as described herein; and

FIGS. 8A-8C are schematic illustrations of a partially hollow overmolded article created using a substantially constant low injection pressure molding machine as described herein.

### DETAILED DESCRIPTION OF THE INVENTION

The present disclosure relates to methods for manufacturing overmolded articles, for example consumer goods, electronics, containers, and the like. The present disclosure may be used in conjunction with, for example, one shot or multi shot injection molding processes and apparatuses, and may also be used with pre-manufactured articles, such as electronic components, plastic packaging, decorations, plastic articles, and the like. A one shot injection molding process may include a single thermoplastic material being injected into a mold cavity, while a multi shot injection molding process may include two separate materials, which may be chemically distinct or chemically identical, injected into the same mold cavity or two separate mold cavities. Different materials may be injected simultaneously or at different times. In some embodiments, a relatively soft material may be injected first, followed by a second injection of a relatively hard material in a reverse overmolding operation. For example, in some embodiments, a relatively soft material may be injected first, followed by a second injection of a relatively harder material in a sequential order that is the reverse of a conventional overmolding operation.

The apparatuses and methods disclosed herein include improved injection molding techniques comprising, in part, substantially constant and low injection pressure to form overmolded articles. The apparatuses and methods disclosed herein may improve overmolded article quality by creating a more consistent and more uniform process that may reduce temperatures and pressures exerted upon pre-manufactured articles during formation and/or injection of the overmolded article, which may affect the types of pre-manufactured articles that may be used during injection molding. Reduced temperatures and pressures during an injection molding process may increase the types of pre-manufactured articles that can be overmolded. For example, electronic devices that that may be damaged by traditional injection molding operations due to having low deformation temperatures may be used with the injection molding processes and apparatuses described herein.

Embodiments of the present disclosure generally relate to systems, machines, products, and methods of producing overmolded articles by overmolding a pre-manufactured article using an injection molding process to form a final overmolded part, and, more specifically, to systems, products, and methods of producing overmolded articles by substantially constant low injection pressure injection molding during the injection stage.

The term “low pressure” as used herein with respect to melt pressure of a thermoplastic material, means melt pressures in a vicinity of a nozzle of an injection molding machine of about 10,000 pounds per square inch (psi) and lower, such as, for example, about 400 psi. Melt pressure within the cavity, including melt pressure against a location on the cavity wall or including melt pressure against the pre-manufactured overmolded article, may be as low as zero psi, or in another example, at atmospheric pressure.

The term “substantially constant pressure” as used herein with respect to a melt pressure of a thermoplastic material, means that deviations from a baseline melt pressure do not produce meaningful changes in physical properties of the thermoplastic material. For example, “substantially constant pressure” includes, but is not limited to, pressure variations for which viscosity of the melted thermoplastic material do not meaningfully change. The term “substantially constant” in this respect includes deviations of approximately +/−30% from a baseline melt pressure. For example, the term “a substantially constant pressure of approximately 32 MPa (about 4,600 psi)” includes pressure fluctuations within the range of about 42 MPa (about 6,000 psi) (30% above 32 MPa (4,600 psi)) to about 22 MPa (about 3,200 psi) (30% below 32 MPa (about 4,600 psi)). A melt pressure is considered substantially constant as long as the melt pressure fluctuates no more than +/−30% from the recited pressure.

The term “melt holder,” as used herein, refers to the portion of an injection molding machine that contains molten plastic in fluid communication with the machine nozzle. The melt holder is heated, such that a polymer may be prepared and held at a desired temperature. The melt holder is connected to a power source, for example a hydraulic cylinder or electric servo motor, that is in communication with a central control unit or controller, and can be controlled to advance a diaphragm to force molten plastic through the machine nozzle. The molten material then flows through the runner system into the mold cavity. The melt holder may be cylindrical in cross section, or have alternative cross sections that will permit a diaphragm to force polymer under pressures that can range from as low as 100 psi to pressures of 40,000 psi or higher through the machine nozzle. The diaphragm may optionally be integrally connected to a reciprocating screw with flights designed to plasticize polymer material prior to injection.

The term “high L/T ratio” generally refers to L/T, or Length-to-Thickness, or Length/Thickness ratios of 100 or greater, and more specifically to L/T ratios of 200 or greater, but less than 1,000. Calculation of the L/T ratio is defined below.

The term “peak flow rate” generally refers to the maximum volumetric flow rate, as measured at the machine nozzle.

The term “peak injection rate” generally refers to the maximum linear speed the injection ram travels in the process of forcing polymer into the feed system. The ram can be a reciprocating screw such as in the case of a single stage injection system, or a hydraulic ram such as in the case of a two stage injection system.

The term “ram rate” generally refers to the linear speed at which the injection ram travels in the process of forcing polymer into the feed system.

The term “flow rate” generally refers to the volumetric flow rate of polymer as measured at the machine nozzle. This flow rate can be calculated based on the ram rate and ram cross sectional area, or measured with a suitable sensor located in the machine nozzle.

The term “cavity percent fill” generally refers to the percentage of the cavity that is filled on a volumetric basis. For example, if a cavity is 95% filled, then the total volume of the mold cavity that is filled is 95% of the total volumetric capacity of the mold cavity.

The term “melt temperature” generally refers to the temperature of the polymer that is maintained in the melt holder and in the material feed system when a hot runner system is used, which keeps the polymer in a molten state. The melt temperature varies by material; however, a desired melt temperature is generally understood to fall within the ranges recommended by the material manufacturer.

The term “gate size” generally refers to the cross sectional area of a gate, which is formed by the intersection of the runner and the mold cavity. For hot runner systems, the gate can be of an open design where there is no positive shut off of the flow of material at the gate, or a closed design where a valve pin is used to mechanically shut off the flow of material through the gate into the mold cavity (commonly referred to as a valve gate). The gate size refers to the cross sectional area, for example a 1 millimeter (mm) gate diameter refers to a cross sectional area of the gate that is equivalent to the cross sectional area of a gate having a 1 mm diameter at the point the gate meets the mold cavity. The cross section of the gate may be of any desired shape.

The term “effective gate area” generally refers to a cross sectional area of a gate corresponding to an intersection of the mold cavity and a material flow channel of a feed system (e.g., a runner) feeding thermoplastic material to the mold cavity. The gate could be heated or may not be heated. The gate could be round, or any cross sectional shape, suited to achieve the desired thermoplastic flow into the mold cavity.

The term “intensification ratio” generally refers to the mechanical advantage the injection power source has on the injection ram forcing the molten polymer through the machine nozzle. For hydraulic power sources, it is common that the hydraulic piston will have a 10:1 mechanical advantage over the injection ram. However, the mechanical advantage can range from ratios much lower, such as 2:1, to much higher mechanical advantage ratio such as 50:1.

The term “peak power” generally refers to the maximum power generated when filling a mold cavity. The peak power may occur at any point in the filling cycle. The peak power is determined by the product of the plastic pressure as measured at the machine nozzle multiplied by the flow rate as measured at the machine nozzle. Power is calculated by the formula P=p*Q where p is pressure and Q is volumetric flow rate.

The term “volumetric flow rate” generally refers to the flow rate as measured at the machine nozzle. This flow rate can be calculated based on the ram rate and ram cross sectional area, or measured with a suitable sensor located in the machine nozzle.

The terms “filled” and “full,” when used with respect to a mold cavity including thermoplastic material, are interchangeable and both terms mean that thermoplastic material has stopped flowing into the mold cavity.

The term “shot size” generally refers to the volume of polymer to be injected from the melt holder to completely fill the mold cavity or cavities. The shot size volume is determined based on the temperature and pressure of the polymer in the melt holder just prior to injection. In other words, the shot size is a total volume of molten plastic material that is injected in a stroke of an injection molding ram at a given temperature and pressure. Shot size may include injecting molten plastic material into one or more injection cavities through one or more gates. The shot of molten plastic material may also be prepared and injected by one or more melt holders.

The term “hesitation” generally refers to the point at which the velocity of the flow front is minimized sufficiently to allow a portion of the polymer to drop below its no flow temperature and begin to freeze off.

The term “electric motor” or “electric press,” when used herein includes both electric servo motors and electric linear motors.

The term “Peak Power Flow Factor” refers to a normalized measure of peak power required by an injection molding system during a single injection molding cycle and the Peak Power Flow Factor may be used to directly compare power requirements of different injection molding systems. The Peak Power Flow Factor is calculated by first determining the Peak Power, which corresponds to the maximum product of molding pressure multiplied by flow rate during the filling cycle (as defined herein), and then determining the shot size for the mold cavities to be filled. The Peak Power Flow Factor is then calculated by dividing the Peak Power by the shot size.

The term “substantially constant low injection pressure molding machine” is defined as a class 101, class 401, or a class 30 injection molding machine that uses a substantially constant injection pressure that is less than or equal to about 69 MPa (about 10,000 psi). Alternatively, the term “substantially constant low injection pressure molding machine” may be defined as an injection molding machine that uses a substantially constant injection pressure that is less than or equal to about 42 MPa (about 6,000 psi). In another embodiment, the term “substantially constant low injection pressure molding machine” may be defined as an injection molding machine that uses a substantially constant injection pressure that is less than or equal to about 69 MPa (about 10,000 psi) and that is capable of performing more than about 100,000 cycles, alternatively more than about 1 million cycles, alternately more than about 1.25 million cycles, alternately more than about 2 million cycles, alternately more than about 5 million cycles, alternately more than about 10 million cycles, or alternatively more than about 1 million cycles to less than about 20 million before the mold core (which is made up of first and second mold parts that define a mold cavity therebetween) reaches the end of its useful life. Characteristics of “substantially constant low injection pressure molding machines” may include, for example, mold cavities having an L/T ratio of greater than 100 (as an example, greater than 200), multiple mold cavities (as an example, 4 mold cavities, as another example, 16 mold cavities, as another example, 32 mold cavities, as another example, 64 mold cavities, as yet another example, 128 mold cavities and as still yet another example 256 mold cavities, or any number of mold cavities between 4 and 512, a heated or cold runner, and/or a guided ejection mechanism.

The term “useful life” is defined as the expected life of a mold part before failure or scheduled replacement. When used in conjunction with a mold part or a mold core (or any part of the mold that defines the mold cavity), the term “useful life” means the time a mold part or mold core is expected to be in service before quality problems develop in the molded part, before problems develop with the integrity of the mold part (e.g., galling, deformation of parting line, deformation or excessive wear of shut-off surfaces), or before mechanical failure (e.g., fatigue failure or fatigue cracks) occurs in the mold part. Typically, the mold part has reached the end of its “useful life” when the contact surfaces that define the mold cavity must be discarded or replaced. The mold parts may require repair or refurbishment from time to time over the “useful life” of a mold part and this repair or refurbishment does not require the complete replacement of the mold part to achieve acceptable molded part quality and molding efficiency. Furthermore, it is possible for damage to occur to a mold part that is unrelated to the normal operation of the mold part, such as a part not being properly removed from the mold and the mold being forcibly closed on the non-ejected part, or an operator using the wrong tool to remove a molded part and damaging a mold component. For this reason, spare mold parts are sometimes used to replace these damaged components prior to them reaching the end of their useful life. Replacing mold parts because of damage does not change the expected useful life.

The term “guided ejection mechanism” is defined as a dynamic part that actuates to physically eject a molded part from the mold cavity.

The term “coating” is defined as a layer of material less than 0.13 mm (0.005 inch) in thickness, that is disposed on a surface of a mold part defining the mold cavity, that has a primary function other than defining a shape of the mold cavity (e.g., a function of protecting the material defining the mold cavity, or a function of reducing friction between a molded part and a mold cavity wall to enhance removal of the molded part from the mold cavity).

The term “average thermal conductivity” is defined as the thermal conductivity of any materials that make up the mold cavity or the mold side or mold part. Materials that make up coatings, stack plates, support plates, and gates or runners, whether integral with the mold cavity or separate from the mold cavity, are not included in the average thermal conductivity. Average thermal conductivity is calculated on a volume weighted basis.

The term “effective cooling surface” is defined as a surface through which heat is removed from a mold part. One example of an effective cooling surface is a surface that defines a channel for cooling fluid from an active cooling system. Another example of an effective cooling surface is an outer surface of a mold part through which heat dissipates to the atmosphere. A mold part may have more than one effective cooling surface and thus may have a unique average thermal conductivity between the mold cavity surface and each effective cooling surface.

The term “nominal wall thickness” is defined as the theoretical thickness of a mold cavity if the mold cavity were made to have a uniform thickness. The nominal wall thickness may be approximated by the average wall thickness. The nominal wall thickness may be calculated by integrating length and width of the mold cavity that is filled by an individual gate.

The term “average hardness” is defined as the Rockwell hardness for any material or combination of materials in a desired volume. When more than one material is present, the average hardness is based on a volume weighted percentage of each material. Average hardness calculations include hardnesses for materials that make up any portion of the mold cavity. Average hardness calculations do not include materials that make up coatings, stack plates, gates or runners, whether integral with a mold cavity or not, and support plates. Generally, average hardness refers to the volume weighted hardness of material in the mold cooling region.

The term “mold cooling region” is defined as a volume of material that lies between the mold cavity surface and an effective cooling surface.

The term “cycle time” is defined as a single iteration of an injection molding process that is required to fully form an injection molded part. Cycle time includes the stages of advancing molten thermoplastic material into a mold cavity, substantially filling the mold cavity with thermoplastic material, cooling the thermoplastic material, separating first and second mold sides to expose the cooled thermoplastic material, removing the thermoplastic material, and closing the first and second mold sides.

Substantially constant low injection pressure molding machines may also be high productivity injection molding machines (e.g., a class 101, 401, or a class 30 injection molding machine, or an “ultra high productivity molding machine”), such as the high productivity injection molding machine disclosed in U.S. patent application Ser. No. 13/601,514, filed Aug. 31, 2012, which is hereby incorporated by reference herein, that may be used to produce thin-walled consumer products, such as toothbrush handles and razor handles. Thin walled parts are generally defined as having a high L/T ratio of 100 or more.

In one or more embodiment of cube molding shown and described herein may comprise a multi shot process, although not required. If multiple shots are used, the shots may each encapsulate a discrete pre-manufactured article or the same pre-manufactured article. The materials that may be used to over mold such pre-manufactured article(s) using a single shot or multiple shot injections of the apparatuses and methods disclosed herein may include but not be limited to materials that have properties such as, for example, thermal conductive, thermal non-conductive, or combinations thereof, electrically conductive, electrically non-conductive, or combinations thereof, optically transparent, optically translucent, optically opaque or combinations thereof, hydrophobic, oleophobic, water resistant, and/or combinations of all the aforementioned.

One or more embodiments of the apparatuses and methods shown and described herein may be used to overmold one or more of the following products and/or one or more subcomponents of such products: aerospace products; agricultural products; appliances; automotive products; building and construction products and/or materials; computers and business machines; consumer products including but not limited to baby care, beauty care, fabric care, home care, family care, feminine care, health care, pet care, small appliances, portable power (e.g., batteries, cells); electrical/electronic equipment; government/defense products; heavy trucks; industrial products; medical/pharmaceutical products; office and other furniture; other transportation; packaging products; recreational/sporting equipment; and telecommunications products.

### Injection Molding Overmolded Articles

Multi-component injection molding, also known as multi-shot molding, two-shot molding, or overmolding may be used to create a composite article, for example an article with load or moment bearing requirements, as well as requirements for large deflections under low forces. Typically, the component of the molded composite article requiring large deformations under low forces is made from a material with a flexural modulus below about 500 MPa, or particularly below about 300 MPa or even more particularly below about 100 MPa, and in some cases as low as about 5 MPa. Many thermoplastic elastomers in the hardness range of from 20 to 100 on the Shore A scale satisfy these requirements. For example, one Shore A 42 TPE may have a flexural modulus of about 7 MPa and a Shore A 50 TPE may have a flexural modulus of about 13 MPa. An example of relatively harder or more rigid thermoplastics such as polypropylene may have a flexural modulus of 1,200 MPa, and an even harder and more rigid thermoplastic such as ABS may have a flexural modulus of 2,400 MPa.

In conventional cases, the softest material is molded as the last material. For example, the elastic properties of a soft component make it difficult to overmold it with a subsequent component at the pressures typically required to injection mold harder components and obtain necessary quality requirements. Injection molding pressures for most thermoplastics typically range from 42 MPa (6,000 psi) to 140 MPa (20,000 psi), which could cause substantial deformation, or engineering strain greater than 10% or particularly engineering strain greater than 50% or more particularly engineering strain greater than 100%, for materials with flexural modulii in this same range or lower. Further, the injection molding pressures for many thermoplastic elastomers are substantially less than that of the relatively harder thermoplastics to which they are overmolded.

Using the apparatuses and methods described herein, thermoplastic elastomers may be injected at pressures much lower than harder thermoplastics without risk of short shots or incomplete cavity filling. Injection pressures from about 1.4 MPa to about 5.6 MPa (from about 200 psi to about 800 psi) are common Although the thermoplastic elastomer is typically injected at a temperature nearly below the melting temperature of the harder thermoplastic material, the typical 1-3 second injection time combined with the low thermal conductivity of the harder thermoplastic prevents most major deformation due to temperature effects. Moreover, the extreme shear thinning nature of thermoplastics, combined with the low injection pressures, means that they do not transfer as much shear force to cavity walls to which they are in intimate contact during injection as would harder thermoplastics molded in a similar cavity. When a cavity wall comprises a harder thermoplastic material, there is less risk of deformation or erosion of that cavity wall when a thermoplastic elastomer is injected versus a harder thermoplastic material as the second shot.

Referring to the figures generally, a pre-manufactured article is positioned (e.g., secured) in a mold cavity of an injection molding apparatus configured as described herein. Thermoplastic material is heated in a melt holder of the injection molding apparatus, or injection molding station, to a predetermined temperature. As discussed below, the predetermined temperature that the thermoplastic material is heated to may be less than a manufacturer's recommended injection temperature, and specifically, less than the lowest recommended manufacturer's injection temperature. For example, if a manufacturer's lowest recommended injection temperature is about 200 degrees Celsius for a certain thermoplastic material, the thermoplastic material may be injected at, for example about 150 degrees Celsius using the apparatuses and methods described herein. Because the thermoplastic material is injected at a lower temperature, less freezing time is required, thereby reducing overall cycle time as well. Using convention injection molding equipment, if the same thermoplastic material was injected at about 150 degrees Celsius, the pressure required to inject the thermoplastic material would be so great and require such power that the size of the equipment would be prohibitively large and uneconomical.

After the thermoplastic material is heated, the thermoplastic material is injected using a plastic melt injection system or injection element into one or more mold cavities of the injection molding apparatus (e.g., a single mold cavity or at least two mold cavities)and allowed to substantially freeze, thereby forming an overmolded article. The overmolded article may subsequently be cooled in some embodiments and/or subject to a second injection process. As discussed in more detail below, overmolded articles produced according to the methods and using the apparatuses described herein may have reduced cycle times, reduced defects, and higher yields. Additionally, due to the low injection temperatures, low melt pressures, and low shear pressures, pre-manufactured articles sensitive to temperature, pressure, and shear pressure may be overmolded using the apparatuses and methods described herein.

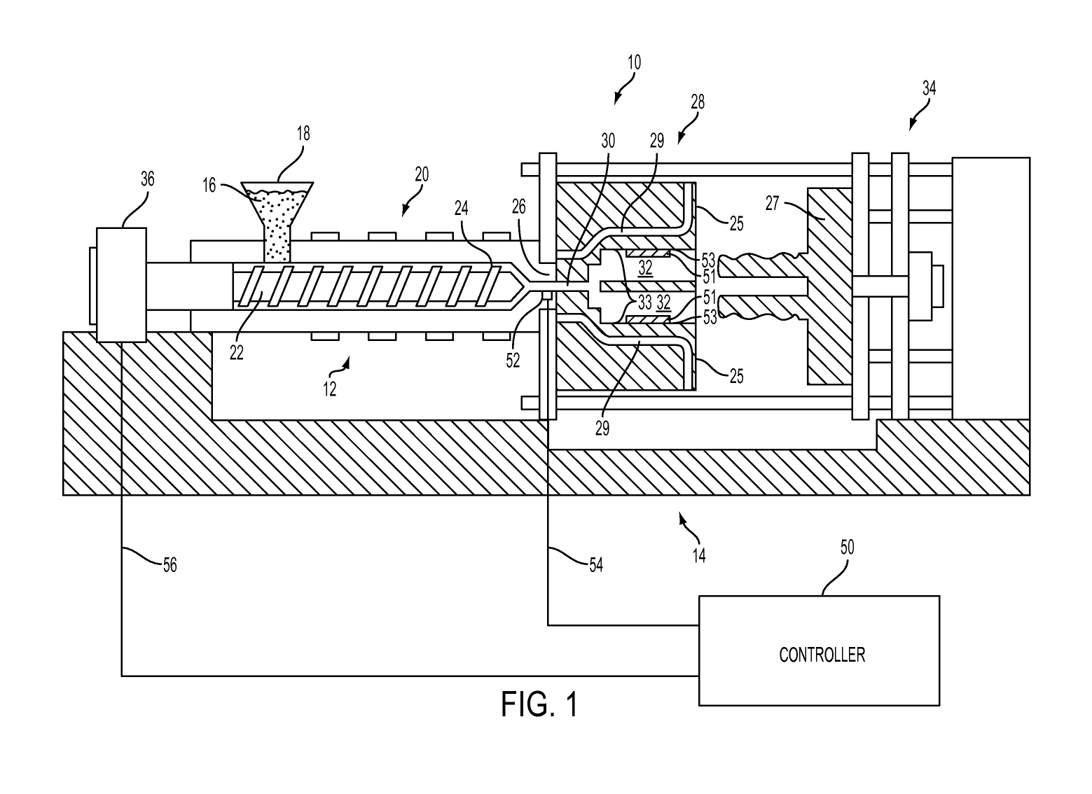

Referring to FIG. 1, one embodiment of a substantially constant low injection pressure molding machine 10 is illustrated. The substantially constant low injection pressure molding machine 10 generally includes a plastic melt injection system 12, a clamping system 14, and a mold 28. A thermoplastic material may be introduced to the plastic melt injection system 12 in the form of thermoplastic pellets 16. The thermoplastic material may directly affect several qualities of the final plastic article, such as stresses, crystallinity, and cooling rates, as well as other qualities. Thermoplastic materials are therefore discussed thoroughly below. The thermoplastic pellets 16 may be placed into a hopper 18, which feeds the thermoplastic pellets 16 into a heated barrel 20 of the plastic melt injection system 12. The thermoplastic pellets 16, after being fed into the heated barrel 20, may be driven to the end of the heated barrel 20 by a reciprocating screw 22. The heating of the heated barrel 20 and the compression of the thermoplastic pellets 16 by the reciprocating screw 22 causes the thermoplastic pellets 16 to melt, forming a molten thermoplastic material 24. The molten thermoplastic material is typically processed at a temperature of about 130 degrees Celsius (° C.) to about 410° C. In one embodiment, the injection molding machine and methods comprises a low injection pressure. In another embodiment, the injection molding machine and method comprises a substantially constant low injection pressure molding machine.

The reciprocating screw 22 forces the molten thermoplastic material 24, toward a nozzle 26 to form a shot of thermoplastic material, which will be injected into a plurality of mold cavities 32 of the mold 28 via an injection element, such as one or more gates 30, preferably three or less gates, that direct the flow of the molten thermoplastic material 24 to the plurality of mold cavities 32. In other embodiments, the nozzle 26 may be separated from one or more gates 30 by a feed system (not shown).

The plurality of mold cavities 32 is formed between a first mold portion 25 and a second mold portion 27 of the mold 28. The first and second mold portions 25, 27 may be formed from a material having high thermal conductivity. For example, the first and second mold portions 25, 27 may be formed from a material having a thermal conductivity of between about 6 watts per meter Kelvin (about 4 BTUs/(hr-ft-° F.)) and about 385 watts per meter Kelvin (about 223 BTUs/(hr-ft-° F.)), or between about 8 watts per meter Kelvin (about 5 BTUs/(hr-ft-° F.)) and about 385 watts per meter Kelvin (about 223 BTUs/(hr-ft-° F.)), or between about 52 (e.g., 51.9) Watts per meter-Kelvin (about 30 BTUs/(hr-ft-° F.)) and about 385 Watts per meter-Kelvin(about 223 BTUs/(hr-ft-° F.)). In still other examples, one or both of the first and second mold portions 25, 27 may be formed from a material having a thermal conductivity of between about 35 BTUs per (hour-foot-° F.) and about 200 BTUs per (hour-foot-° F.); or between about 40 BTUs per (hour-foot-° F.) and about 190 BTUs per (hour-foot-° F.); or between about 50 BTUs per (hour-foot-° F.) and about 180 BTUs per (hour-foot-° F.); or between about 75 BTUs per (hour-foot-° F.) and about 150 BTUs per (hour-foot-° F.).

Some illustrative materials [expand out to include hardened tool steels starting at about 5 Rc for manufacturing all or portions of the first and/or second mold portions 25, 27 include hardened steels such as, for example, hardened tool steels having an Rc from about 100 Rc or less, from about 60 Rc or less, from about 50 Rc or less, from about 35 Rc or less, from about 10 Rc or less, from about 5 Rc to about 10 Rc, from about 5 Rc to about 35 Rc, from about 5 Rc to about 50 Rc, from about 5 Rc, to about 100 Rc. Some additional illustrative materials for manufacturing all or portions of the first and/or second mold portions 25, 27 include aluminum (for example, 2024 aluminum, 2090 aluminum, 2124 aluminum, 2195 aluminum, 2219 aluminum, 2324 aluminum, 2618 aluminum, 5052 aluminum, 5059 aluminum, aircraft grade aluminum, 6,000 series aluminum, 6013 aluminum, 6056 aluminum, 6061 aluminum, 6063 aluminum, 7000 series aluminum, 7050 aluminum, 7055 aluminum, 7068 aluminum, 7075 aluminum, 7076 aluminum, 7150 aluminum, 7475 aluminum, QC-10, Alumold™, Hokotol™, Duramold 2™, Duramold 5™, and/or Alumec 99™), BeCu (for example, C17200, C 18000, C61900, C62500, C64700, C82500, Moldmax LH™, Moldmax HH™, and/or Protherm™), Copper, and any alloys of aluminum (e.g., Beryllium, Bismuth, Chromium, Copper, Gallium, Iron, Lead, Magnesium, Manganese, Silicon, Titanium, Vanadium, Zinc, and/or Zirconium), any alloys of copper (e.g., Magnesium, Zinc, Nickel, Silicon, Chromium, Aluminum, and/or Bronze).

Additionally, non-homogeneous materials may be used, wherein a combination of dissimilar metals or metal alloys are combined or intrinsically bonded, for example via compatible intermetallic alloys, to create a mold component that is preferentially harder on one side than another, or in certain embodiments more or less thermally conductive in one volumetric element or another. Alloys in the families above may be included in these non-homogeneous mold components. One example of such a mold component contains a Cu core clad in a very hard surface coating of Fe—Cr—V bonded intrinsically together via the intermetallic alloys in the sequence of: Copper, Iron-Nickel (Fe—Ni), Iron-Chrome (Fe—Cr), Iron-Chrome-Vanadium (Fe—Cr—V). These materials may have Rockwell C (Rc) hardnesses of between about 0.5 Rc and about 20 Rc, particularly between about 2 Rc and about 20 Rc, more particularly between about 3 Rc and about 15 Rc, and more particularly between about 4Rc and about 10 Rc. The first and/or second mold portions 25, 27 may be comprised solely of any one of these materials or any combination of these materials. For example, the mold 28 may comprise aluminum and/or an aluminum containing core.

The disclosed substantially constant low injection pressure molding methods and machines operate under molding conditions that permit molds made of softer, higher thermal conductivity materials to extract useful lives of more than about 100,000 cycles, more than about 200,000 cycles, more than about 500,000 cycles, more than about 700,000 cycles, more than about 1 million cycles, for example between about 100,000 cycles and about 2,000,000 cycles, between about 100,000 cycles and about 1,500,000 cycles, between about 1 million cycles and about 10 million cycles, particularly between about 1.25 million cycles and about 10 million cycles, and more particularly between about 2 million cycles and about 5 million cycles.

The mold 28 may also include a cooling circuit 29, integrated into or positioned proximate to either or both the first or second mold portions 25, 27. The cooling circuit 29 may provide a path for cooling fluid to pass through one or both portions of the mold 28. The cooling fluid may remove heat from the mold 28 or a portion 25, 27 of the mold, thereby reducing the temperature of the mold 28 and in some instances, reducing the temperature of an overmolded article contained within the mold cavity 32. As the cooling fluid passes through the mold 28, a cooling fluid temperature may be measured. For example, the cooling fluid temperature may be measured as the cooling fluid is at its nearest point to the mold cavities 32, as it enters the mold 28, or as it leaves the mold 28. The cooling fluid temperature as it reaches the mold 28 may be determined by a chiller, as discussed herein. In some embodiments, the cooling circuit 29 may have a spiral flow path, while in other embodiments, the cooling circuit 29 may have a planar, curved, linear, or other flow path.

High thermal conductivity of the mold 28 (e.g., the first mold part 25 and/or second mold part 27) may alleviate the need for dehumidification apparatuses, as differences in temperature between the mold and the ambient environment may be reduced. Further, thermal lag in the mold may be reduced due to the high thermal conductivity of the mold. This may enable the use of, for example, evaporative cooling fluids and/or closed circuit systems.

In embodiments where the mold 28 includes the plurality of mold cavities 32, overall production rates may be increased. As discussed above, for any of the embodiments of molds described herein, any of the molds can be configured in the closed position to form between 2 mold cavities and 512 mold cavities, or any integer value for mold cavities between 2 mold cavities and 512 mold cavities, or within any range formed by any of these values, such as between 64 and 512, between 128 and 512, between 4 and 288 mold cavities, between 16 and 256 mold cavities, between 32 and 128 mold cavities, etc. The shapes of the cavities of each of the plurality of mold cavities may be identical, similar, or different from each other. The mold cavities may also be formed from more than two mold portions. In embodiments where the shapes of the plurality of mold cavities are different from each other, the plurality of mold cavities may be considered a family of mold cavities.

In the embodiment illustrated in FIG. 1, a pre-manufactured article 51 is secured in at least one of the plurality of mold cavities 32. The pre-manufactured article 51 may be any article that is to be partially or completely overmolded by a thermoplastic material. For example, the pre-manufactured article 51 may be any one or a combination of articles such as, for example, metal screws, magnets, electronic subassemblies, Radio Frequency Identification (RFID) tags, an electronic component, a soldered component, a component comprising fluid such as a liquid (e.g., a snow globe), or a gas such as air, nitrogen, or argon, a component comprising ink, a component comprising combustible material with a flash point below the predetermined temperature, a ceramic article, a hollow or partially hollow article, a medical device component, brush bristles, a mirror, a sponge, a rubber product (e.g. gasket), a lead-based solder, a lead free solder, a light emitting diode, a battery, a resistor, a capacitor, an inductor, a microcontroller, an operational amplifier, an electronic device (e.g., cell phone, smart phone), a binary or ternary

Eutectic alloy.

Additional examples of pre-manufactured articles 51 include a label, an ornament, an indicator, a barrier, a gripping element, a textured element, and a tactile element. As discussed below, temperature and/or pressure sensitive pre-manufactured articles, such as decorative labels with printed sides, may be used with the apparatuses and methods of overmolding described herein. Articles may be sensitive to different components of the stress or viscous shear tensor to different degrees. For example, articles may be most sensitive to hydrostatic pressure components (diagonal components of the stress or viscous shear tensor) and less sensitive to shear (off-diagonal) components, or vice versa. Hollow articles, or other articles likely to experience volumetric changes when subjected to hydrostatic pressures, would be more sensitive to diagonal components of the shear tensor. Flat, thin or other high-aspect-ratio articles on the other hand, may develop little volumetric deformation when subjected to even high hydrostatic stresses, but would fail either in part, or grossly, when subjected to high sliding forces and shear stresses caused by molten plastic dragging across one surface of the article. An in-mold labels is one example of an article sensitive to shear stresses or shear strains that is less sensitive to hydrostatic forces: A label placed into mold cavity and held by some mechanism such as electrostatic forces or vacuum (or some other method known to those familiar in the art) will be subjected to drag forces of the moving plastic, translated as shear stresses, and may experience strain, deformation or even bulk movement as a result of these forces. These shear forces, strains and stresses would be substantially in proportion to the rate of motion or velocity of the injected plastic.

The pre-manufactured article 51 may be positioned (e.g., secured) by an attachment portion 53, which may be integrated into each mold cavity 32. In other embodiments, the pre-manufactured article 51 may be positioned (e.g., secured) using adhesives, clamps, protrusions, or other securing mechanisms and/or methods to secure the pre-manufactured article 51 inside the mold cavity 32. The pre-manufactured article 51 may contain adhesive, for example, or adhesive may be applied to a mold surface 33.

The first and second mold portions 25, 27 are held together under pressure by a press or clamping unit 34. The press or clamping unit 34 applies a clamping force during the molding process that is greater than the force exerted by the injection pressure acting to separate the first and second mold portions 25, 27, thereby holding the first and second mold portions 25, 27 together while the molten thermoplastic material 24 is injected into the plurality of mold cavities 32. To support these clamping forces, the clamping system 14 may include a mold frame and a mold base. As discussed below, the molten thermoplastic material 24 is injected into the plurality of mold cavities 32 at a substantially constant melt pressure of at least about 400 psi and at most about 10,000 psi. In one example, the clamp tonnage for the clamping system 14 may be less than about 2 tons per square inch of projected molding area. It is understood that the clamping system 14 may have other clamp tonnage, both higher and lower than the illustrative 2 tons per square inch of projected molding area set forth above.

The thermoplastic material 24 is heated to a predetermined temperature. The thermoplastic material 24 may be heated to a predetermined temperature that is less than the manufacturer's lowest recommended injection temperature for that specific thermoplastic material. Generally, manufacturers provide a range of melt or injection temperatures for a specific material at which the thermoplastic material is easily injected. Using the apparatuses and methods described herein, the thermoplastic material may be heated to a predetermined temperature that is less than the lowest temperature recommended by the manufacturer, for example about 100 degrees Celsius less than the lowest recommended temperature, or about 75 degrees Celsius less than the lowest recommended temperature, or about 50 degrees Celsius less than the lowest recommended temperature, or about 40 degrees Celsius less than the lowest recommended temperature, or about 25 degrees Celsius less than the lowest recommended temperature. By another measurement, the predetermined temperature to which the thermoplastic material is heated may be about 30 degrees Celsius less than a heat deflection temperature or plastic or elastic deformation temperature of the pre-manufactured article. Heated thermoplastic material 24 is advanced into the plurality of mold cavities 32 until the plurality of mold cavities 32 is substantially filled. The molten thermoplastic material 24 may be advanced at a melt temperature measured as the thermoplastic material 24 leaves the injection element and enters at least one of the plurality of mold cavities 32. The plurality of mold cavities 32 may be substantially filled when the plurality of mold cavities 32 is more than 90% filled, in another example, more than 95% filled and in another example, more than 99% filled. Once the shot of molten thermoplastic material 24 is injected into the plurality of mold cavities 32, the reciprocating screw 22 stops traveling forward.

A controller 50 is communicatively connected with a sensor 52, which may be located in the vicinity of the nozzle 26, the injection element or gates 30, and a screw control 36. The controller 50 may include a microprocessor, a memory, and one or more communication links When melt pressure and/or melt temperature of the thermoplastic material is measured by the sensor 52, this sensor 52 may send a signal indicative of the pressure or the temperature to the controller 50 to provide a target pressure for the controller 50 to maintain in the plurality of mold cavities 32 (or in the nozzle 26) as the fill is completed. This signal may generally be used to control the molding process, such that variations in material viscosity, mold temperatures, melt temperatures, and other variations influencing filling rate, are adjusted by the controller 50. These adjustments may be made immediately during the molding cycle, or corrections can be made in subsequent cycles. Furthermore, several signals may be averaged over a number of cycles and then used to make adjustments to the molding process by the controller 50. The controller 50 may be connected to the sensor 52 and the screw control 36 via wired connections 54, 56, respectively. In other embodiments, the controller 50 may be connected to the sensor 52 and screw control 36 via a wireless connection, a mechanical connection, a hydraulic connection, a pneumatic connection, or any other type of communication connection known to those having ordinary skill in the art that will allow the controller 50 to communicate with both the sensor 52 and the screw control 36 (e.g., a feedback loop).

In the embodiment of FIG. 1, the sensor 52 is a pressure sensor that measures (directly or indirectly) melt pressure of the molten thermoplastic material 24 n the vicinity of the nozzle 26. The thermoplastic material 24 may be injected at a maximum melt pressure that is within 30% of a minimum melt pressure of the thermoplastic material entering the at least two mold cavities, such that the melt pressure is substantially constant. Similar to the manufacturer's recommended injection temperature, manufacturers generally provide recommended injection or melt pressure ranges, a sample of which is reproduced below. Using the apparatuses and methods described herein, the melt pressure of the thermoplastic material entering the at least two mold cavities may be less than the lowest manufacturer's recommended injection pressure.

The sensor 52 generates an electrical signal that is transmitted to the controller 50. The controller 50 then commands the screw control 36 to advance the screw 22 at a rate that maintains a desired melt pressure of the molten thermoplastic material 24 in the nozzle 26. While the sensor 52 may directly measure the melt pressure, the sensor 52 ay also indirectly measure the melt pressure by measuring other characteristics of the molten thermoplastic material 24, such as temperature, viscosity, flow rate, etc., which are indicative of melt pressure. Likewise, the sensor 52 need not be located directly in the nozzle 26, but rather the sensor 52 may be located at any location within the plastic melt injection system 12 or mold 28 that is fluidly connected with the nozzle 26. If the sensor 52 is not located within the nozzle 26, appropriate correction factors may be applied to the measured characteristic to calculate an estimate of the melt pressure in the nozzle 26. The sensor 52 need not be in direct contact with the injected material and may alternatively be in dynamic communication with the material and able to sense the pressure of the material and/or other fluid characteristics. If the sensor 52 is not located within the nozzle 26, appropriate correction factors may be applied to the measured characteristic to calculate the melt pressure in the nozzle 26. In yet other embodiments, the sensor 52 need not be disposed at a location that is fluidly connected with the nozzle 26. Rather, the sensor 52 could measure clamping force generated by the clamping system 14 at a mold parting line between the first and second mold portions 25, 27. In one aspect, the controller 50 may maintain the pressure according to the input from sensor 52. Alternatively, the sensor 52 could measure an electrical power demand by an electric press, which may be used to calculate an estimate of the pressure in the nozzle 26.

Although an active, closed loop controller 50 is illustrated in FIG. 1, other pressure regulating devices may be used instead of the closed loop controller 50. For example, a pressure regulating valve (not shown) or a pressure relief valve (not shown) may replace the controller 50 to regulate the melt pressure of the molten thermoplastic material 24. More specifically, the pressure regulating valve and pressure relief valve can prevent overpressurization of the mold 28. Another alternative mechanism for preventing overpressurization of the mold 28 is an alarm that is activated when an overpressurization condition is detected.

The substantially constant low injection pressure molding machine 10 may further use another sensor (such as the sensor 52 in FIG. 1 above) located near an end of flow position (i.e., near an end of the mold cavity) to monitor changes in material viscosity, changes in material temperature, and changes in other material properties. Measurements from this sensor may be communicated to the controller 50 to allow the controller 50 to correct the process in real time to ensure the melt front pressure is relieved prior to the melt front reaching the end of the plurality of mold cavities 32, which can cause flashing of the mold 28, and another pressure and power peak. Moreover, the controller 50 may use the sensor measurements to adjust the peak power and peak flow rate points in the process, so as to achieve consistent processing conditions. In addition to using the sensor measurements to fine tune the process in real time during the current injection cycle, the controller 50 may also adjust the process over time (e.g., over a plurality of injection cycles). In this way, the current injection cycle can be corrected based on measurements occurring during one or more cycles at an earlier point in time. In one embodiment, sensor readings can be averaged over many cycles so as to achieve process consistency.

Upon injection into the plurality of mold cavities 32, the molten thermoplastic material 24 contacts the mold contact surface 33 within each mold cavity 32 and takes the form of the plurality of mold cavities 32 and the molten thermoplastic material 24 cools inside the mold 28 until the thermoplastic material 24 solidifies or is substantially frozen. The molten thermoplastic material 24 may be actively cooled with an active cooling apparatus that includes a cooling liquid flowing through at least one of the first and second mold portions 25, 27, or passively cooled through convection and conduction to the atmosphere, as discussed below. Once the thermoplastic material 24 has solidified, the press 34 releases the first and second mold portions 25, 27. At which point, the first and second mold portions 25, 27 are separated from one another, and the finished part, in this embodiment a overmolded article, may be ejected from the mold 28. The overmolded article may be ejected or removed by, for example, ejection, dumping, releasing, removing, extraction (manually or via an automated process, including robotic action), pulling, pushing, gravity, or any other method of separating the cooled overmolded article from the first and second mold portions 25, 27. After the cooled overmolded article is removed from the first and second mold portions 25, 27, the first and second mold portions 25, 27 may be closed, reforming the plurality of mold cavities 32. The reforming of the plurality of mold cavities 32 prepares the first and second mold portions 25, 27 to receive a new shot of molten thermoplastic material, thereby completing a single mold cycle. Cycle time is defined as a single iteration of the molding cycle.

During the injection molding process, heat from the molten thermoplastic material 24 may be transferred to the mold 28, thereby increasing the mold temperature. The cooling system or cooling circuit may assist in maintaining a portion of, or the entire, mold 28 and/or plurality of mold cavities 32 at a temperature below the no-flow temperature of the thermoplastic material 24. For example, even surfaces of the plurality of mold cavities 32 which contact the shot comprising molten thermoplastic material 24 can be cooled to maintain a lower temperature. Any suitable cooling temperature can be used, such as about 10 degrees Celsius. For example, the mold 28 can be maintained substantially at room temperature. Incorporation of such cooling systems can advantageously enhance the rate at which the as-formed injection molded part is cooled and ready for ejection from the mold. Additionally, because of the high thermal conductivity of the molds described herein, the mold may not retain all or most of the heat, as heat transferred to the mold may be subsequently transferred to the cooling fluid over a short period of time. For example, the mold 28 may have or maintain a temperature of greater than or equal to about 90 degrees Celsius during the injection stage of the molten thermoplastic material, which may avoid condensation on or around the mold 28, thereby eliminating the need for dehumidification apparatuses In some examples, the mold temperature may be set just slightly above the dew point, and in other examples, portions of the mold, for example, near the gate, the mold temp may up to and even slightly above the Material Ejection Temperature, or material crystallization temperature, or material solidification temperature.

Cooling circuits may allow for heat to be removed from the plurality of mold cavities 32, and for the temperature of the overmolded article formed within the plurality of mold cavities 32 to be reduced. The cooling circuit may be, for example, a spiral cooling circuit positioned in both the first and second mold portions 25, 27. In other embodiments, the cooling circuit may comprise straight tubing. The cooling circuit may be configured to direct a cooling fluid, such as water, to and away from the first and second mold portions 25, 27 such that heat is removed from the plurality of mold cavities 32 (and thus the thermoplastic material and/or the formed overmolded article) and transferred to the cooling fluid. The cooling fluid may be fluidically coupled to a chiller system (not shown) to remove heat retained in the cooling fluid. Due to the thermal conductivity of the mold 28, the heat transferred to the cooling fluid from the mold 28 should be fairly uniform and efficient, in that the temperature throughout the mold 28 should remain substantially similar. Heat removed from the mold 28 may further remove heat from the overmolded article, resulting in substantially balanced cooling and more efficient cooling for the overmolded article, which may reduce stresses molded into the overmolded article, and may also substantially balance, or otherwise make more uniform, stresses molded into the overmolded article.

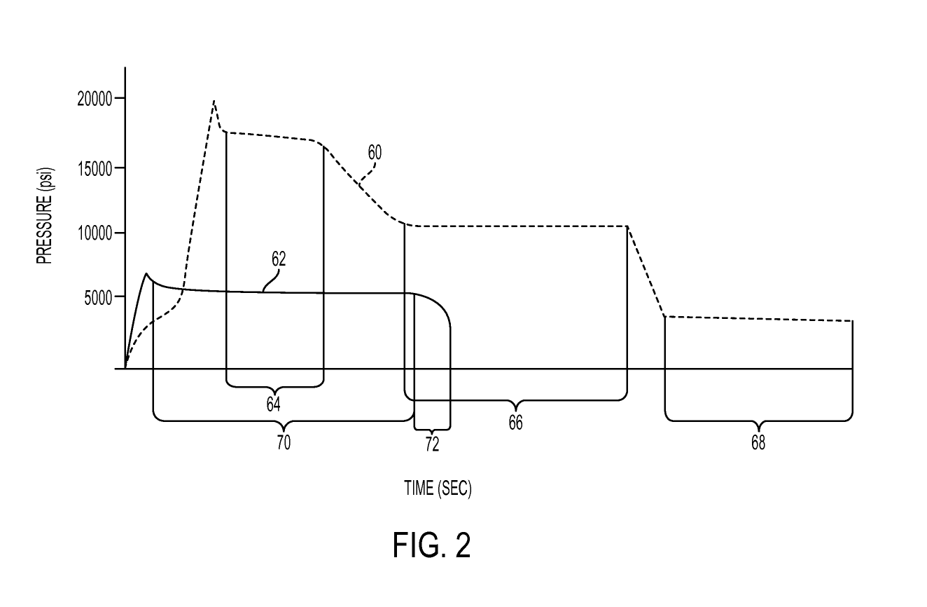

Referring now to FIG. 2, a typical pressure-time curve for a conventional high variable pressure injection molding process is illustrated by the dashed line 60. By contrast, a pressure-time curve for the disclosed substantially constant low injection pressure molding machine is illustrated by the solid line 62.

In the conventional case, melt pressure is rapidly increased to well over about 15,000 psi and then held at a relatively high pressure, more than about 15,000 psi, for a first period of time 64. The first period of time 64 is the fill time in which molten plastic material flows into the mold cavity. Thereafter, the melt pressure is decreased and held at a lower, but still relatively high pressure, typically about 10,000 psi or more, for a second period of time 66. The second period of time 66 is a packing time in which the melt pressure is maintained to ensure that all gaps in the mold cavity are back filled. After packing is complete, the pressure may optionally be dropped again for a third period of time 68, which is the cooling time. The mold cavity in a conventional high variable pressure injection molding system is packed from the end of the flow channel back to towards the gate. The material in the mold typically freezes off near the end of the cavity, then the completely frozen off region of material progressively moves toward the gate location, or locations. As a result, the plastic near the end of the mold cavity is packed for a shorter time period and with reduced pressure than the plastic material that is closer to the gate location, or locations. Part geometry, such as very thin cross sectional areas midway between the gate and end of mold cavity, can also influence the level of packing pressure in regions of the mold cavity. Inconsistent packing pressure may cause inconsistencies in the finished product, including uneven wall thickness, unbalanced stresses, and high levels of crystallinity. Moreover, the conventional packing of plastic in various stages of solidification results in some non-ideal material properties, for example, molded-in stresses, sink, and non-optimal optical properties.

The substantially constant low injection pressure molding machine 10, on the other hand, injects the molten plastic material into the mold cavity at a substantially constant pressure for a fill time period 70. The injection pressure in the example of FIG. 2 is less than about 69 MPa (about 10,000 psi). In another embodiment, the injection pressure is less than about 42 MPa (about 6,000 psi). Other embodiments may use lower pressures. In another example, the injection pressure from about 2 MPa (about 400 psi) to about 69 MPa (about 10,000 psi). After the mold cavity is filled, the substantially constant low injection pressure molding machine 10 gradually reduces pressure over a second time period 72 as the molded part is cooled. By using a substantially constant pressure, the molten thermoplastic material maintains a continuous melt flow front that advances through the flow channel from the gate towards the end of the flow channel In other words, the molten thermoplastic material remains moving throughout the mold cavity, which prevents premature freeze off. Thus, the plastic material remains relatively uniform at any point along the flow channel, which results in a more uniform and consistent finished product. By filling the mold with a relatively uniform pressure, the finished molded parts form crystalline structures that may have better mechanical and optical properties than conventionally molded parts. Moreover, the parts molded at constant pressures exhibit different characteristics than skin layers of conventionally molded parts. As a result, parts molded under constant pressure may have better optical properties than parts of conventionally molded parts.

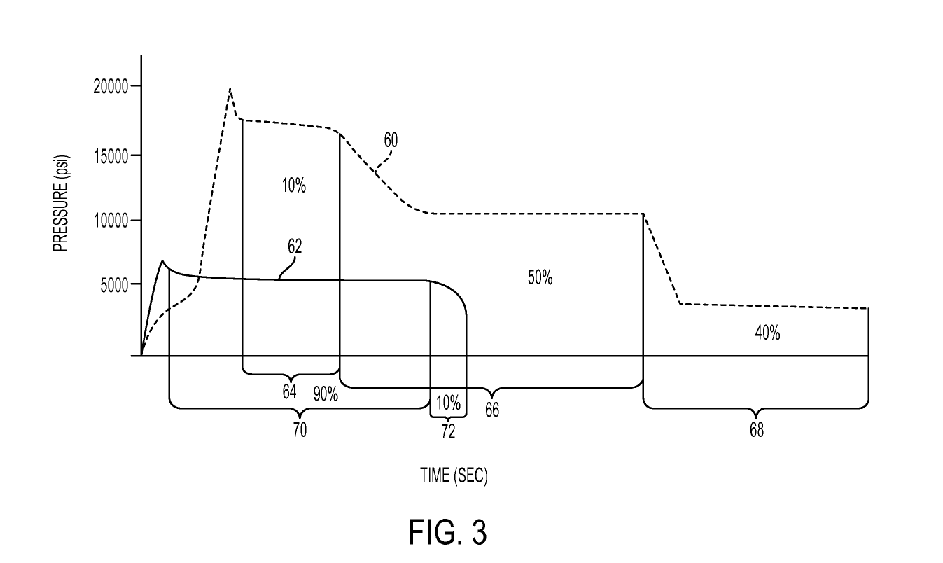

Turning now to FIG. 3, the various stages of fill are broken down as percentages of overall fill time. For example, in a conventional high variable pressure injection molding process, the fill period 64 comprises about 10% of the total fill time, the packing period 66 comprises about 50% of the total fill time, and the cooing period 68 comprises about 40% of the total fill time. On the other hand, in some examples of the substantially constant pressure injection molding process described herein, the fill period 70 comprises about 90% of the total fill time while the cooling period 72 comprises only about 10% of the total fill time. In some other examples of the substantially constant pressure injection molding process described herein, the cooling period 72 may comprise about 50% of the fill time or about 25% of total fill time. The substantially constant pressure injection molding process needs less cooling time because the molten plastic material is cooling as it is flowing into the mold cavity. Thus, by the time the mold cavity is filled, the molten plastic material has cooled significantly, although not quite enough to freeze off in the center cross section of the mold cavity, and there is less total heat to remove to complete the freezing process. Additionally, because the molten plastic material remains liquid throughout the fill, and packing pressure is transferred through this molten center cross section, the molten plastic material remains in contact with the mold cavity walls (as opposed to freezing off and shrinking away). As a result, the substantially constant pressure injection molding process described herein is capable of filling and cooling a molded part in less total time than in a conventional high variable pressure injection molding process.

Peak power and peak flow rate vs. percentage of mold cavity fill are illustrated in FIG. 3 for both conventional high variable pressure processes 60 and for substantially constant pressure processes 62. In the substantially constant pressure process 62, the peak power load occurs at a time approximately equal to the time the peak flow rate occurs, and then declines steadily through the filling cycle. More specifically, the peak power and the peak flow rate occur in the first 30% of fill, and in another example, in the first 20% of fill, and in yet another example, in the first 10% of fill. By arranging the peak power and peak flow rate to occur during the beginning of fill, the thermoplastic material is not subject to the extreme conditions when it is closer to freezing. It is believed that this results in superior physical properties of the molded parts.

The power level generally declines slowly through the filling cycle following the peak power load. Additionally, the flow rate generally declines slowly through the filling cycle following the peak flow rate because the fill pressure is maintained substantially constant. As illustrated above, the peak power level is lower than the peak power level for a conventional process, generally from about 30 to about 50% lower and the peak flow rate is lower than the peak flow rate for a conventional process, generally from about 30 to about 50% lower.

Similarly, the peak power load for a conventional high variable pressure process occurs at a time approximately equal to the time the peak flow rate occurs. However, unlike the substantially constant process, the peak power and flow rate for the conventional high variable ressure process occur in the final 10%-30% of fill, which subjects the thermoplastic material to extreme conditions as it is in the process of freezing. Also unlike the substantially constant pressure process, the power level in the conventional high variable pressure process generally declines rapidly through the filling cycle following the peak power load. Similarly, the flow rate in a conventional high variable pressure process generally declines rapidly through the filling cycle following the peak flow rate.

Alternatively, in one or more embodiments shown and described herein, the peak power may be adjusted to maintain a substantially constant injection pressure. More specifically, the filling pressure profile may be adjusted to cause the peak power to occur in the first 30% of the cavity fill, in another example, in the first 20% of the cavity fill, and in yet another example, in the first 10% of the cavity fill. Adjusting the process to cause the peak power to occur within the specific ranges, and then to have a decreasing power throughout the remainder of the cavity fill results in the same benefits for the molded part that were described above with respect to adjusting peak flow rate. Moreover, in one or more embodiments of the substantially constant pressure injection molding method and/or machine, adjusting the process in the manner described may be used when overmolding thinwall parts (e.g., L/T ratio >100) and for large shot sizes (e.g., more than 50 cc, in particular more than 100 cc).

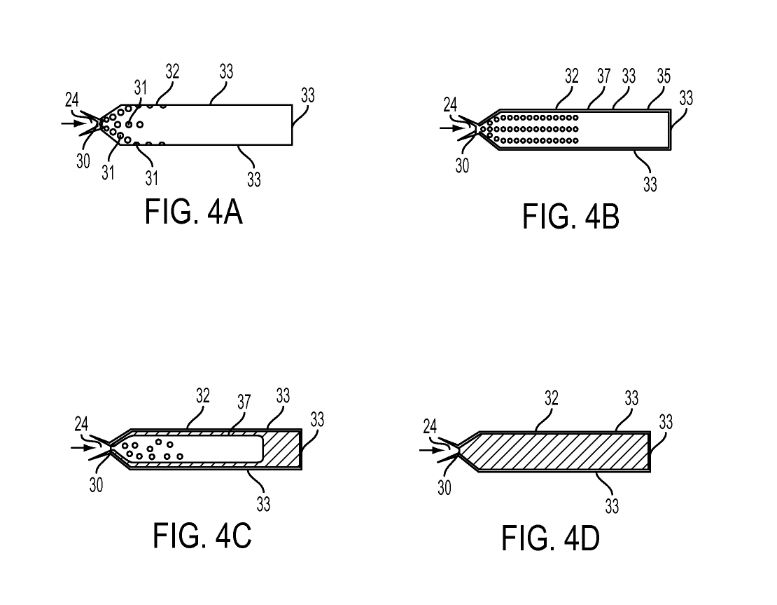

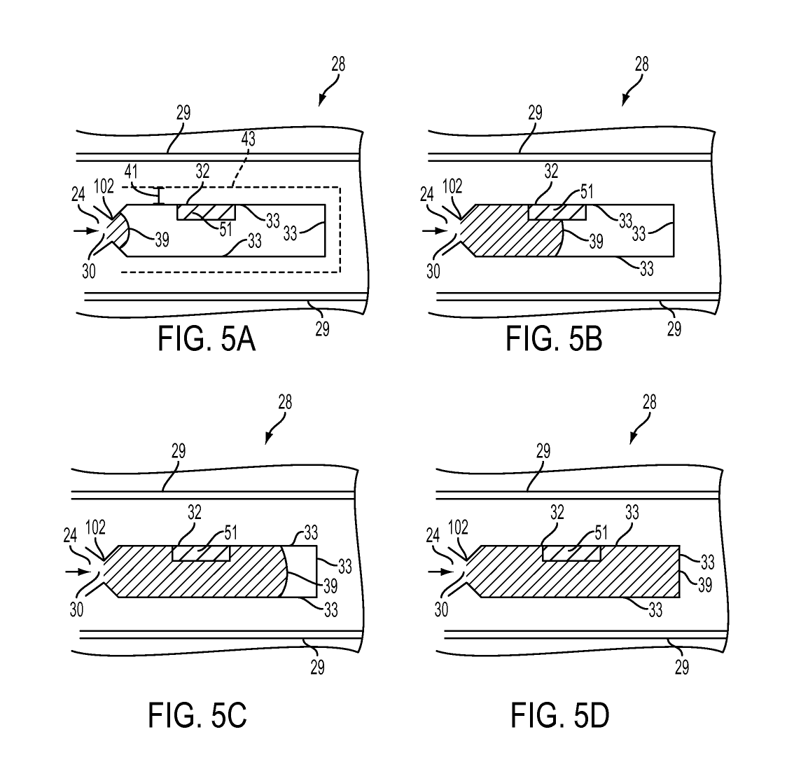

Turning now to FIGS. 4A-4D and FIGS. 5A-5D a portion of a mold cavity as it is being filled by a conventional high variable pressure injection molding machine (FIGS. 4A-4D) and as it is being filled by a substantially constant pressure injection molding machine with a pre-manufactured article 51 (FIGS. 5A-5D) of the disclosure herein is illustrated.

As illustrated in FIGS. 4A-4D, as the conventional high variable pressure injection molding machine begins to inject molten thermoplastic material 24 into a plurality of mold cavities 32 through the gate 30, the high injection pressure tends to inject the molten thermoplastic material 24 into the plurality of mold cavities 32 at a high rate of speed, which causes the molten thermoplastic material 24 to flow in laminates 31, most commonly referred to as laminar flow (FIG. 4A). These outermost laminates 31 adhere to mold overmolded article contact surfaces 33 of the mold cavity and subsequently cool and freeze, forming a frozen boundary layer 37 (FIG. 4B), before the plurality of mold cavities 32 is completely full. As the thermoplastic material freezes, however, it also shrinks away from the wall of the plurality of mold cavities 32, leaving a gap 35 between the mold cavity wall and the boundary layer 37. This gap 35 reduces cooling efficiency of the mold. Molten thermoplastic material 24 also begins to cool and freeze in the vicinity of the gate 30, which reduces the effective cross-sectional area of the gate 30. In order to maintain a constant volumetric flow rate, the conventional high variable pressure injection molding machine must increase pressure to force molten thermoplastic material through the narrowing gate 30. As the thermoplastic material 24 continues to flow into the plurality of mold cavities 32, the boundary layer 37 grows thicker (FIG. 4C). Eventually, the entire plurality of mold cavities 32 is substantially filled by thermoplastic material that is frozen (FIG. 4D). At this point, the conventional high pressure injection molding machine must maintain a packing pressure to push the receded boundary layer 37 back against the plurality of mold cavities 32 walls to increase cooling.

Referring now to FIGS. 5A-5D, the substantially constant low injection pressure molding machine 10, on the other hand, flows molten thermoplastic material into a plurality of mold cavities 32 with a constantly moving flow front 39. The thermoplastic material 24 behind the flow front 39 remains molten until the mold cavity 32 is substantially filled (e.g., about 99% or more filled) before freezing. As a result, there is no reduction in effective cross-sectional area of the gate 30, and a constant injection pressure is maintained. Moreover, because the thermoplastic material 24 is molten behind the flow front 39, the thermoplastic material 24 remains in contact with the walls of the plurality of mold cavities 32. As a result, the thermoplastic material 24 is cooling (without freezing) during the fill portion of the molding process. Thus, the cooling portion of the injection molding process need not be as long as a conventional process.

Because the thermoplastic material remains molten and keeps moving into the plurality of mold cavities 32, less injection pressure is required than in conventional molds. In one embodiment, the injection pressure may be about 42 MPa (about 6,000 psi) or less. As a result, the injection systems and clamping systems need not be as powerful. For example, the disclosed substantially constant injection pressure devices may use clamps requiring lower clamping forces, and a corresponding lower clamping power source. Moreover, the disclosed injection molding machines, because of the lower power requirements, may employ electric presses, which are generally not powerful enough to use in conventional high variable pressure injection molding method and/or machine (e.g., class 101 and 102 injection molding machines). Even when electric presses are sufficient to use for some simple, molds with few mold cavities, the process may be improved with the disclosed substantially constant injection pressure methods and devices as smaller, less expensive electric motors may be used. The disclosed substantially constant injection pressure molding machines may comprise one or more of the following types of electric presses, a direct servo drive motor press, a dual motor belt driven press, a dual motor planetary gear press, and/or a dual motor ball drive press having a power rating of 200 HP or less.

Due to the reduced melt temperature and injection pressures used with the methods described herein, shear force exerted by the thermoplastic material 24 on the pre-manufactured article 51 as it fills the mold cavity 32 is reduced, when compared to thermoplastic material injected at a higher pressure. Accordingly, pre-manufactured articles with shear pressure sensitive components that experience deformation at a pre-manufactured article upper shear pressure limit may be overmolded using one or more of the substantially constant injection pressure method and/or machine shown and described herein. Specifically, the thermoplastic material is injected at a melt pressure that produces a shear pressure inside the at least two mold cavities between the thermoplastic material and the pre-manufactured article of less than the pre-manufactured article upper shear pressure limit, which is made possible by the substantially constant, low injection pressure methods and/or machines disclosed herein.

When filling at a substantially constant pressure, it was conventionally thought that the filling rates would need to be reduced relative to conventional filling methods. This means the polymer would be in contact with the cool molding surfaces for longer periods before the mold would completely fill. Thus, more heat would need to be removed before filling, and this would be expected to result in the material freezing off before the mold is filled.

However, to the contrary, when using the substantially constant injection pressure molding machines and methods shown and described herein, the thermoplastic material will flow when subjected to substantially constant pressure conditions despite a portion of the mold cavity being below the no-flow temperature of the thermoplastic material. It would be generally expected by one of ordinary skill in the art that such conditions would cause the thermoplastic material to freeze and plug the mold cavity rather than continue to flow and fill the entire mold cavity. Without intending to be bound by theory, it is believed that the substantially constant pressure conditions of embodiments of the disclosed method and machine allow for dynamic flow conditions (i.e., constantly moving melt front) throughout the entire mold cavity during filling. There is no hesitation in the flow of the molten thermoplastic material as it flows to fill the mold cavity and, thus, no opportunity for freeze-off of the flow despite at least a portion of the mold cavity being below the no-flow temperature of the thermoplastic material.

Additionally, it is believed that as a result of the dynamic flow conditions, the molten thermoplastic material is able to maintain a temperature higher than the no-flow temperature, despite being subjected to such temperatures in the mold cavity, as a result of shear heating. It is further believed that the dynamic flow conditions interfere with the formation of crystal structures in the thermoplastic material as it begins the freezing process. Crystal structure formation increases the viscosity of the thermoplastic material, which can prevent suitable flow to fill the cavity. The reduction in crystal structure formation and/or crystal structure size can allow for a decrease in the thermoplastic material viscosity as it flows into the cavity and is subjected to the low temperature of the mold that is below the no-flow temperature of the material.

Once the thermoplastic material is injected, the overmolded article and, optionally the cavity, may be cooled. The overmolded article and the cavity may be allowed to cool passively or actively. Passive cooling could involve simply leaving the overmolded article to cool naturally within the mold. Active cooling may involve using a further device to assist and accelerate cooling. Active cooling may be achieved by passing a coolant, typically water, close to the mold, or blowing cool air, as another coolant example, at the cavity and/or product. The coolant absorbs the heat from the mold and keeps the mold at a suitable temperature to solidify the material at the most efficient rate. The mold (e.g., mold 28) can be opened when the part has solidified sufficiently to retain its shape, enabling the material to be demolded from the mold cavity without damage. However, the overmolded article may not be ejected from the molding unit. More preferably the overmolded article is cooled using coolant which passed close to, but separate from the molding unit. Cooling can take from about 1 second to about 60 seconds, or from about 1 second to about 30 seconds, or from about 1 second to about 15 seconds, or from about 2 to about 10 seconds, or from about 3 to about 8 seconds. Although not required, actively cooling is beneficial to decreasing cycle times of the manufacturing process.

### Reverse Overmolding

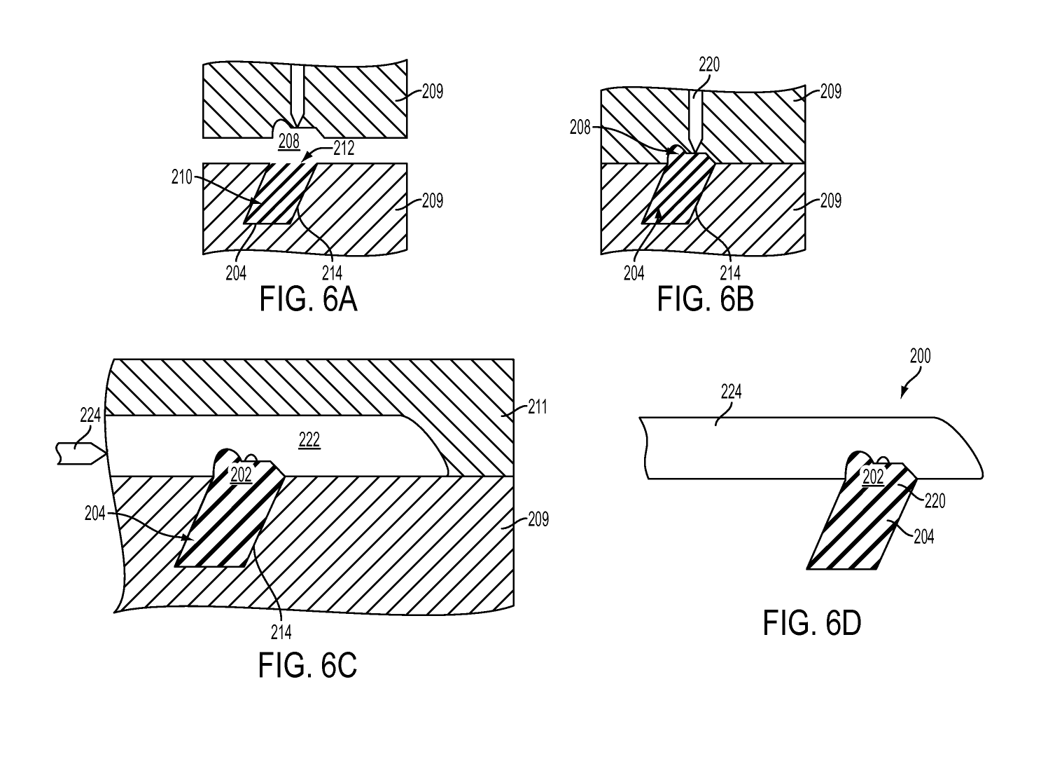

Referring now to FIGS. 6A-6D, further stages may be incorporated into one or more embodiments of the substantially constant injection pressure molding machines and methods of the present disclosure. In one embodiment, the substantially constant injection pressure molding machine and method of the present disclosure may include multiple injection stages or co-injection stages. In this embodiment, a first material may be injected into the mold cavity to produce a first portion of the overmolded article. The first portion of the overmolded article may then be cooled to a temperature low enough to allow further mold operations without damaging the overmolded article. After the first portion of the overmolded article is cooled and sufficiently solid, the mold cavity shape is changed. A second material can then be co-injected into the new cavity shape to make a second portion of the overmolded article. The overmolded article is made in such a way that the materials from the first and second injections are in direct contact with one another, allowing the materials to bond at the location(s) of direct contact. Hence, the temperature of both portions of the overmolded article is, in this embodiment, sufficient to achieve bonding. The second material to be injected can be the same material as the first material, or different. Alternatively two materials may be co-injected simultaneously into the first cavity during a co-injection technique. If both the first and the second materials are the same or chemically similar, thermal bonding between them is improved. It is also possible to inject different thermoplastic material, allowing the product to have multiple characteristics, such as different transparency, opacity or flexibility.

In some embodiments, the overmolded article may be added to the first molded portion, then overmolded with a second molded portion,—encapsulating the overmolded article. This may accomplished in one or more portions such as, for example, one portion, two portions, three portions, and so on. Also, in some other embodiments, the overmolded article may be encapsulated by one material (for example, a conductive or non-conductive material, or a very soft or hard material, or a high or low thermal conductive material, waterproof material and/or hydrophobic material, etc.) The first layer of material may be designed to ensure no damage or optimal performance of the overmolded article (the article could be thermal (heat or cold) sensitive, conductivity sensitive, shear sensitive, pressure sensitive, liquid sensitive, and etc.). In these or other embodiments of the apparatuses and methods shown and described herein may include one or more overmolded article, and that these articles may be encapsulated with one or more different materials to impart the appropriate performance requirements desired for the overmolded article. Also, in one or more of the embodiments of the apparatuses and methods shown and described herein, the shots of material used do not all have to be low constant pressure. One or more of shots of material preceding or following the low constant pressure shot may comprise medium pressure, high pressure, or combinations thereof. For example, the first overmolded shot may be injected at low constant pressure to cover a delicate portion of an article (e.g., pre-manufactured), which then serves to protect the overmolded article during a higher-pressure subsequent shot (second shot) or vice versa.

For example, turning to FIGS. 6A-6D, a brush head 200 may be manufactured using the apparatuses and methods described herein, where the brush head 200 includes a head carrier 202 supporting a plurality of brush bristles 204, with the brush bristles 204 being comprised of a material relatively softer than the head carrier 202 and the brush head 200. In some embodiments, the brush bristles 204 may be significantly softer than the head carrier 202 and/or the brush head 200 and may have a heat deflection temperature, melt temperature, or plastic or elastic deformation temperature that is significantly less than the heat deflection temperature, melt temperature, or plastic or elastic deformation temperature of the brush head 200 or the head carrier 202, for example about 20 degrees Celsius less, about 30 degrees Celsius less, about 40 degrees Celsius less, about 50 degrees Celsius less, about 60 degrees Celsius less, about 70 degrees Celsius less, or about 100 degrees Celsius less.

According to one method described herein, in FIG. 6A, one end 210 of the plurality of brush bristles 204 may be secured in a mold cavity 208 of a mold 209, with a free end 212 of the brush bristles 204 extending away from the mold cavity surface 214 into the mold cavity 208. In FIG. 6B, the mold 209 is closed and a first relatively soft thermoplastic material 220 may be injected into the mold cavity 208 using the injection methods described herein, thereby encompassing the brush bristles 204 secured in the mold cavity 208. The first relatively soft thermoplastic material 220 may then be allowed to substantially freeze, thereby defining the head carrier 202 of the brush head 200, shown in FIG. 6C. The head carrier 202 may then be moved or transferred to a second mold cavity 211, shown in FIG. 6C. In some embodiments, the head carrier 202 may remain fixed and only a portion of the mold may change, as shown in FIG. 6C. A second relatively hard thermoplastic material 224 may then be injected into a second mold cavity 222, such that the head carrier 202 is at least partially covered or overmolded by the second relatively hard thermoplastic material 224. Because the second thermoplastic material 224 is relatively harder than the first thermoplastic material 220, the second thermoplastic material 224 may have a higher melt or heat deformation temperature than the first thermoplastic material 220. Therefore, some remelt of the first thermoplastic material 220 may occur upon contact with the second thermoplastic material 224 during injection. However, with the apparatuses and methods described herein, since the second thermoplastic material 224 may be injected at a significantly lower temperature than suggested by the manufacturer, the amount of remelt or other damage to the first thermoplastic material 220 is limited and significantly less than the damage that may occur using a conventional process. Accordingly, although brush bristles are used in this illustration, applications where electrical components, electronics, or other highly temperature sensitive, pressure sensitive, or liquid sensitive pre-manufactured articles may be overmolded using the methods described herein that may not otherwise be capable of overmolding using other processes.

Using the apparatuses and methods described herein, a substantially harder thermoplastic material may be injected in an overmolding operation over a first relatively soft thermoplastic material. In some embodiments, the second thermoplastic material may be about 10 times or 1000% harder than the first thermoplastic material, while in other embodiments, the second thermoplastic material may be about 100% harder than the first thermoplastic material, about 90% harder than the first thermoplastic material, or about 75% harder than the first thermoplastic material, or about 60% harder than the first thermoplastic material, or about 50% harder than the first thermoplastic material, or about 30% harder than the first thermoplastic material. Hardness may be quantified on a linear scale by modulus of elasticity or flexural modulus, or on one of many scales familiar to those in the art such as the Shore A scale, Shore D scale, Vickers scale, Brinnel scale or any of the Rockwell scales. In many cases, the scales commonly used to measure hardness for the first and second thermoplastic materials may be different or incompatible or non-scaling. In these cases, percentage differences in hardness should be taken to mean substantially in proportion to percentage differences in either modulus of elasticity or flexural modulus. In other embodiments, a deformation stress of the first thermoplastic material may be less than a deformation stress of the second thermoplastic material. In other embodiments, a flexural modulus of the first thermoplastic material may be substantially less, for example about 90% less, or one order of magnitude less than an flexural modulus of the second thermoplastic material. In still further embodiments, an elastic modulus of the first thermoplastic material may be substantially less, for example about 90% less, or one order of magnitude less than an elastic modulus of the second thermoplastic material.

### Design Critical Overmolded Articles

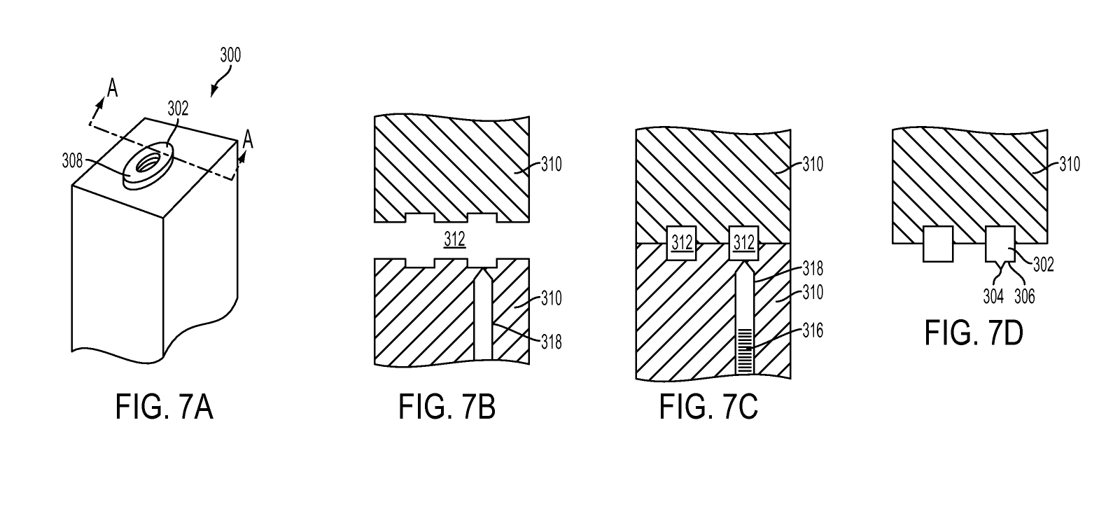

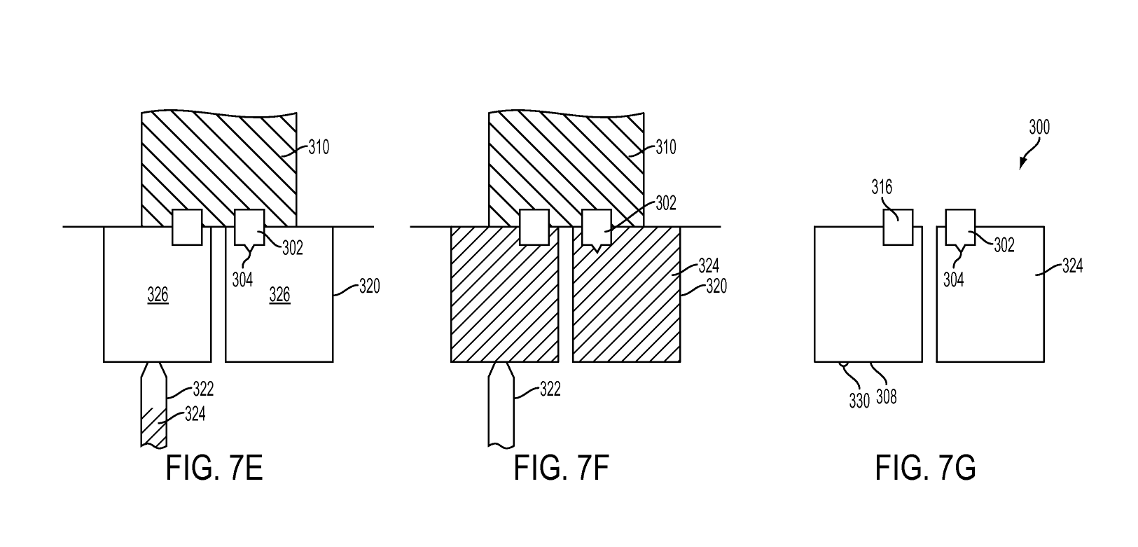

Referring now to FIGS. 7A-7G, in another embodiment, one or more of the substantially constant injection pressure molding machines and methods of the present disclosure may be used in applications where, for example, flush sealing is desired. By using the apparatuses and methods described herein, injection gate or vestige location can be manipulated. Referring first to FIG. 7A, a molded part 300 with a sealing gasket 302 is depicted. Molding of the sealing gasket 302 requires some vestige 304 (shown in FIG. 7D) to be present on a surface of the sealing gasket 302 at the injection gate location. However, using the methods described herein, the vestige 304 may be formed on an inner surface 306 of the sealing gasket 302, thereby leaving a smooth outer surface 308 for a flush seal using the sealing gasket 302. Specifically, since the sealing gasket 302 may be formed from a material softer than the remainder of the molded part 300, use of the reverse overmolding methods discussed above may be employed in order to relocate the vestige.

Referring now to FIG. 7B, a cross-sectional view along line A-A of the molded part 300 is depicted. A mold 310 comprises mold cavity 312, formed when the mold 310 is in a closed position, as shown in FIG. 7C. Thermoplastic material 316 is injected through injection gate 318 into the mold cavity 312. The mold 310 is then opened, shown in FIG. 7D, leaving behind the sealing gasket 302 and vestige 304 on the inner surface 306 of the sealing gasket 302. The vestige 304 is created when the mold 310 is opened and residue from the injection gate 318 remains behind. The sealing gasket 302 may then be transferred to a second mold 320, which forms the body of the molded part 300, illustrated in FIG. 7E. As second thermoplastic material 324, which may be a harder material, is injected into mold cavity 326 through injection gate 322, the mold cavity 326 is filled, as shown in FIG. 7F. The mold 310, 320 is then opened and the molded part 300 removed, as shown in FIG. 7G. The vestige 304 of the sealing gasket 302 is positioned internally of the molded part 300, and a vestige 330 appears on a lower surface 332 of the molded part 300. However, the sealing gasket 302 now has a flush outer surface 308 that may be used for improved sealing. In the case of multi-cavity molds, it is possible that cavities may not be identical or substantially identical in geometry. In addition, not all cavities in a multi-cavity mold may contain a pre-manufactured article to be overmolded. For example, a mold family for a cellular phone case may include a back case, a front case, and an internal chassis, said internal chassis including a pre-manufactured electronic printed circuit board which is overmolded as part of the multi-cavity family mold, said electronic printed circuit board being sensitive to temperature due to low melting temperature of soldered components.

### Partially Hollow Articles as Pre-Manufactured Articles

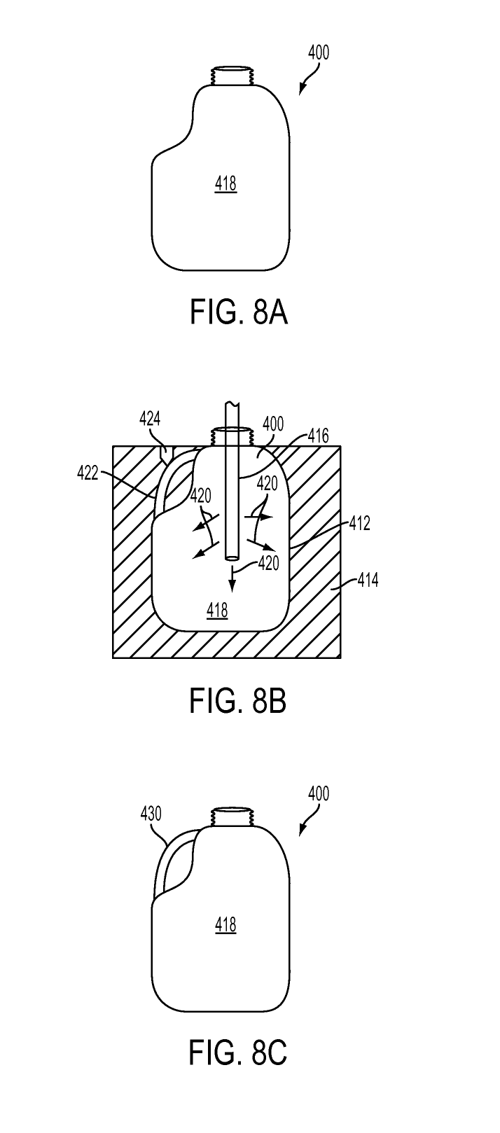

Referring now to FIGS. 8A-8C, in another embodiment, one or more of the substantially constant injection pressure molding machines and methods of the present disclosure may be used to overmold a handle 410 on a partially hollow or fully hollow article such as, for example, bottle 400, a hollow thermoplastic toothbrush handle manufactured using gas-assist injection molding or extrusion blow molding. In other embodiments, the pre-manufactured article may be a partially hollow article selected from the group consisting of a container, a handle, a decoration, an ornament, a float, a bead, a tool, and a utensil.

In this method, the bottle 400, shown in FIG. 8A, may be at least partially or fully hollow with a hollow portion 418. In some embodiments, a body of the partially hollow article may include a plurality of walls having a wall thickness, and the body of the partially hollow article may have a wall strength dependent upon the wall thickness.

The bottle 400 is secured in a mold cavity 412 formed by mold 414, as shown in cross-sectional view in FIG. 8B. A fluid injecting device 416 may be inserted into the hollow portion 418 of the bottle 400 or other partially hollow article. The fluid injecting device 416 may inject fluid (e.g., nitrogen, air, argon), into the hollow portion 418 of the bottle 400, thereby increasing the structural rigidity and/or wall strength of the bottle 400. The fluid injecting device 416 may inject fluid such that fluid flows omnidirectionally from the fluid injecting device 416, as indicated by arrows 420, increasing the internal pressure of the bottle 400 against the wall(s) of the bottle 400. In some instances, the wall strength of the body of the partially hollow article may be increased by between about 15% to about 30% while the partially hollow article is inflated, for example.

A second thermoplastic material may be injected through gate 424 into an unfilled portion 422 of the mold cavity 412. The second thermoplastic material may have a chemical affinity for the material of the bottle 400, for example, and as such, may bond to form a handle 430 connected to the bottle 400, as shown in FIG. 8C.

Use of the substantially constant injection pressure molding machines and methods described herein can offer a substantial improvement for overmolding processes, and can provide many of the advantages of the conventional process of molding a TPE over PP, but reversing the order of the process. First, the lowering of the injection pressure of a second component, or harder material, will reduce the likelihood of gross deformation of the first, softer component at any points of contact between the first and second materials. The use of high-speed feedback and control of the injection pressure can allow substantial reductions in injection pressure of relatively hard thermoplastics. Second, the lower injection pressure corresponds to a slower injection rate. For example, instead of injecting at about 100mm/s, it may be possible to inject at about 10 mm/s or in another example, about 5mm/s, with less risk of gate freeze. At these lower injection pressures, there is less shear in the plastic, and thus less shear of the plastic against any cavity wall to which it comes in intimate contact. The injected thermoplastic will transfer a lower magnitude of shear force to the wall of the cavity comprising the thermoplastic elastomer, and will thus tend to deform it less by nature of shear than would thermoplastic injected in a conventional overmolding process.

As the injection speed decreases for a given part, the injection time must increase substantially in proportion, as the difference in part density for a slowly-injected part is substantially the same for a conventionally-injected part. Not to be limited by theory, this increase in injection time during injection of the harder thermoplastic material may lead to undesired re-melting of the thermoplastic elastomer near the injection gate. For this reason, an again, not to be limited by theory, in some embodiments the harder thermoplastic may be injected at some injection pressure that is greater than the minimum possible pressure to inject and still maintain suitable finished part quality. In this case, a lower bound on injection pressure may be dictated by part geometry and thermoplastic elastomer material properties.

The one or more embodiments of the substantially constant injection pressure molding machines and methods described herein allow for improved balanced heat removal from internal and external surfaces of the overmolded article. The overmolded articles produced using the apparatuses and methods described herein may further allow for improved cooling, due to the reduced thermal gradient between the thermoplastic material and the mold itself. The thermal conductivity of the injection mold allows for the thermoplastic material to be cooled more quickly, allowing for faster cycle time and may result in higher quality overmolded articles. Additionally, because of the thermal conductivity of the mold, any cooling circuit or cooling fluid may be maintained at a higher temperature, reducing the load on any chillers required for temperature maintenance, thereby reducing manufacturing costs.

Increased mold temperature, and therefore a reduced temperature gradient between the mold temperature and the molten thermoplastic material also may result in reduced and more uniform stresses contained within the overmolded article. The temperature gradient between the center of the overmolded article and the walls of the overmolded article may also be reduced. Additionally, improved cooling of the overmolded article may result in more uniform internal and external stresses contained in overmolded articles, as well as reduced and more uniform crystallinity. Further, the substantially constant low injection pressure injection molding process used to create overmolded articles may improve consistency of overmolded articles across a family of molds. For example, a overmolded article formed in a first cavity may be substantially similar to a overmolded article formed in a sixty-fourth cavity, particularly when compared to a high injection pressure injection molding process.

The one or more embodiments of the substantially constant injection pressure molding machines and methods described herein may further allow for consistently packing the mold so that at the end of fill region the injection pressure is similar to the injection pressure at the front of fill region. This may result in a reduced risk of overpacking the mold and reduced molded-in stresses in the overmolded article. Additionally, part weight may be decreased, which may reduce costs associated with creating the overmolded article.

A further advantage of overmolding the soft, elastic material with a harder material, especially for thick-walled (e.g., from about 3mm to about 15mm) articles, is the ability of the soft material to compress reversibly during overmolding, so that the shrink that occurs naturally during solidification and cooling of the harder material can be at least partially mitigated by the ‘packing’ of the harder material from the inside toward the mold cavity wall by elastic forces of the thermoplastic elastomer in compression.

### Thermoplastic Materials, Additives, and Manufacturer's Recommended Injection Pressure Ranges

The overmolded article articles discussed herein are made using a thermoplastic material. Any suitable thermoplastic material may be useful herein. Such thermoplastic materials may include normally solid polymers and resins. In general, any solid polymer of an aliphatic mono-1-olefin can be used within the scope of this disclosure. Examples of such materials include polymers and copolymers of aliphatic mono-1-olefins, such as ethylene, propylene, butene-1, hexene-1, octene-1, and the like, and blends of these polymers and copolymers. Polymers of aliphatic mono-1-olefins having a maximum of 8 carbon atoms per molecule and no branching nearer the double bond than the fourth position provide products having particularly desirable properties. Other thermoplastic materials that can be used in the practice of the disclosure include the acrylonitrile-butadiene-styrene resins, cellulosics, copolymers of ethylene and a vinyl monomer with an acid group such as methacrylic acid, phenoxy polymers, polyamides, including polyamide-imide (PAI), polycarbonates, vinyl copolymers and homopolymer, polymethylmethacrylate, polycarbonate, diethyleneglycol bisarylcarbonate, polyethylene naphthalate, polyvinyl chloride, polyurethane, epoxy resin, polyamide-based resins, low-density polyethylene, high-density polyethylene, low-density polypropylene, high-density polypropylene, polyethylene terephthalate, styrene butadiene copolymers, acrylonitrile, acrylonitrile-butadiene copolymer, cellulose acetate butyrate and mixtures thereof, polyaryletherketone (PAEK or Ketone), polybutadiene (PBD), polybutylene (PB, Polybutylene terephthalate (PBT), Polyetheretherketone (PEEK), Polyetherimide (PEI), Polyethersulfone (PES), Polyethylenechlorinates (PEC), Polyimide (PI), Polylactic acid (PLA), Polymethylpentene (PMP), Polyphenylene oxide (PPO), Polyphenylene sulfide (PPS), Polyphthalamide (PPA), Polystyrene (PS), Polysulfone (PSU), Polyvinyl chloride (PVC), Polyvinylidene chloride (PVDC), and Spectralon. Further preferred materials include Ionomers, Kydex, a trademarked acrylic/PVC alloy, Liquid Crystal Polymer (LCP), Polyacetal (POM or Acetal), Polyacrylates (Acrylic), Polyacrylonitrile (PAN or Acrylonitrile), Polyamide (PA or Nylon), Polyamide-imide (PAI), Polyaryletherketone (PAEK or Ketone), Polybutadiene (PBD), Polybutylene (PB), Polybutylene terephthalate (PBT), Polyethylene furanoate (PEF),

Polyethylene terephthalate glycol-modified (PETG), Poly(cyclohexanedimethylene terephthalate) (PCT), Poly(cyclohexanedimethylene terephthalate) glycol modified (PCTG), Poly(cyclohexylene dimethylene terephthalate)-acid (PCTA), and Polytrimethylene terephthalate (PTT), and mixtures thereof.

Other thermoplastic materials that can be used in the practice of the disclosure include the group of thermoplastic elastomers, known as TPE, which include styrenic block copolymers, polyolefin blends, elastomeric alloys (TPE-v and TPV), thermoplastic polyurethanes (TPU), thermoplastic copolyester and thermoplastic polyamides.

Additional illustrative thermoplastic materials are those selected from the group consisting of polyolefins and derivatives thereof. In other examples, the thermoplastic material is selected from the group consisting of polyethylene, polypropylene, including low-density, but particularly high-density polyethylene and polypropylene, polyethylene terephthalate, polyethylene furanoate (PEF), thermoplastic elastomers from polyolefin blends and mixtures thereof.

Further illustrative polyolefins include, but are not limited to, polymethylpentene and polybutene-1. Any of the aforementioned polyolefins could be sourced from bio-based feedstocks, such as sugarcane or other agricultural products, to produce a bio-polypropylene or bio-polyethylene. Polyolefins may demonstrate shear thinning when in a molten state. Shear thinning is a reduction in viscosity when the fluid is placed under compressive stress. Shear thinning can beneficially allow for the flow of the thermoplastic material to be maintained throughout the injection molding process. Without intending to be bound by theory, it is believed that the shear thinning properties of a thermoplastic material, and in particular polyolefins, results in less variation of the materials viscosity when the material is processed at constant pressures. As a result, one or more embodiments of the substantially constant injection pressure molding machines and methods of the present disclosure can be less sensitive to variations in the thermoplastic material, for example, resulting from colorants and other additives as well as processing conditions. This decreased sensitivity to batch-to-batch variations of the properties thermoplastic material can also advantageously allow post-industrial and post consumer recycled plastics to be processed using embodiments of the apparatuses and methods of the present disclosure. Post-industrial, post consumer recycled plastics are derived from end products that have completed their life cycle as a consumer item and would otherwise have been disposed of as a solid waste product. Such recycled plastic, and blends of thermoplastic materials, inherently have significant batch-to-batch variation of their material properties.

The overmolded articles and injection molded articles using one or more embodiments of the substantially constant injection pressure molding machines and methods of the present disclosure may be formed from a virgin resin, a reground or recycled resin, petroleum derived resins, bio-derived resins from plant materials, and combinations of such resins. The containers may comprise fillers and additives in addition to the base resin material. Exemplary fillers and additives include colorants, cross-linking polymers, inorganic and organic fillers such as calcium carbonate, opacifiers, and processing aids as these elements are known in the art.

The thermoplastic material can also be, for example, a polyester. Illustrative polyesters include, but are not limited to, polyethylene terphthalate (PET). The PET polymer could be sourced from bio-based feedstocks, such as sugarcane or other agricultural products, to produce a partially or fully bio-PET polymer. Other suitable thermoplastic materials include copolymers of polypropylene and polyethylene, and polymers and copolymers of thermoplastic elastomers, polyester, polystyrene, polycarbonate, poly(acrylonitrile-butadiene-styrene), poly(lactic acid), bio-based polyesters such as poly(ethylene furanate) polyhydroxyalkanoate, poly(ethylene furanoate), (considered to be an alternative to, or drop-in replacement for, PET), polyhydroxyalkanoate, polyamides, polyacetals, ethylene-alpha olefin rubbers, and styrene-butadiene-styrene block copolymers. The thermoplastic material can also be a blend of multiple polymeric and non-polymeric materials. The thermoplastic material can be, for example, a blend of high, medium, and low molecular polymers yielding a multi-modal or bi-modal blend. The multi-modal material can be designed in a way that results in a thermoplastic material that has superior flow properties yet has satisfactory chemo/physical properties. The thermoplastic material can also be a blend of a polymer with one or more small molecule additives. The small molecule could be, for example, a siloxane or other lubricating molecule that, when added to the thermoplastic material, improves the flowability of the polymeric material.

Other additives may include inorganic fillers such calcium carbonate, calcium sulfate, talcs, clays (e.g., nanoclays), aluminum hydroxide, CaSiO3, glass formed into fibers or microspheres, crystalline silicas (e.g., quartz, novacite, crystallobite), magnesium hydroxide, mica, sodium sulfate, lithopone, magnesium carbonate, iron oxide; or, organic fillers such as rice husks, straw, hemp fiber, wood flour, or wood, bamboo or sugarcane fiber.

Additional aesthetic or functional additives includes a fragrance, a color, a pearlescent agent, an anti-bacterial agent, an ultraviolet light barrier, a fluorescent or phosphorescent agent, a thermochromic material, a foaming agent, a feel agent or a slip agent. In embodiments where a foaming agent is mixed with the resin prior to injection, bubbles of gas may be formed inside the resin as the thermoplastic material is injected. This may cause high pressure in the injection element, which is released into the mold cavity. When the thermoplastic material comes into contact with the mold cavity surfaces, the outer skin of the thermoplastic material solidifies, while a plurality of voids remain internally. This practice may lead to a reduction in weight and material usage for the molded part in the range of about 10% to about 50% less than without a foaming agent. Because of this, pre-manufactured articles may include sealed or unsealed voids, or a plurality of voids, where the void may be volumetrically greater than 5% of a solid portion of the total displaced volume of the pre-manufactured article.

Other suitable thermoplastic materials include renewable polymers such as nonlimiting examples of polymers produced directly from organisms, such as polyhydroxyalkanoates (e.g., poly(beta-hydroxyalkanoate), poly(3-hydroxybutyrate-co-3-hydroxyvalerate, NODAX (Registered Trademark)), and bacterial cellulose; polymers extracted from plants, agricultural and forest, and biomass, such as polysaccharides and derivatives thereof (e.g., gums, cellulose, cellulose esters, chitin, chitosan, starch, chemically modified starch, particles of cellulose acetate), proteins (e.g., zein, whey, gluten, collagen), lipids, lignins, and natural rubber; thermoplastic starch produced from starch or chemically starch and current polymers derived from naturally sourced monomers and derivatives, such as bio-polyethylene, bio-polypropylene, polytrimethylene terephthalate, polylactic acid, NYLON 11, alkyd resins, succinic acid-based polyesters, and bio-polyethylene terephthalate.

The suitable thermoplastic materials may include a blend or blends of different thermoplastic materials such in the examples cited above. As well the different materials may be a combination of materials derived from virgin bio-derived or petroleum-derived materials, or recycled materials of bio-derived or petroleum-derived materials. One or more of the thermoplastic materials in a blend may be biodegradable. And for non-blend thermoplastic materials, the thermoplastic material may be biodegradable.

The molten thermoplastic material described herein may have a viscosity, as defined by the melt flow index (MFI), of about 0.1 g/10 min to about 500 g/10 min, as measured by ASTM D1238 performed at temperature of about 230 degrees Celsius with a about 2.16 kg weight. For example, for polypropylene the melt flow index can be in a range of about 0.5 g/10 min to about 200 g/10 min Other suitable melt flow indexes include about 1 g/10 min to about 400 g/10 min, about 10 g/10 min to about 300 g/10 min, about 20 to about 200 g/10 min, about 30 g/10 min to about 100 g/10 min, about 50 g/10 min to about 75 g/10 min, about 0.1 g/10 min to about 1 g/10 min, or about 1 g/10 min to about 25 g/10 min The MFI of the material is selected based on the application and use of the molded article. For examples, thermoplastic materials with an MFI of about 0.1 g/10 min to about 5 g/10 min may be suitable for use as overmolded articles for ISBM applications. Thermoplastic materials with an MFI of about 5 g/10 min to about 50 g/10 min may be suitable for use as caps and closures for packaging articles. Thermoplastic materials with an MFI of about 50 g/10 min to about 150 g/10 min may be suitable for use in the manufacture of buckets or tubs. Thermoplastic materials with an MFI of about 150 g/10 min to about 500 g/10 min may be suitable for molded articles that have extremely high L/T ratios such as a thin plate. Manufacturers of such thermoplastic materials generally teach that the materials should be injection molded using melt pressures in excess of about 42 MPa (about 6,000 psi), and often in great excess of about 42 MPa (about 6,000 psi). Contrary to conventional teachings regarding injection molding of such thermoplastic materials, embodiments of the substantially constant injection pressure molding machine and method of the present disclosure allow for forming quality injection molded parts using such thermoplastic materials and processing at melt pressures below about 69 MPa (about 10,000 psi) or about 42 MPa (about 6,000 psi), and possibly well below about 42 MPa (about 6,000 psi).

Exemplary thermoplastic resins together with their manufacturer's recommended injection pressure ranges are provided in the following table (all numerical values provided in the table below may be preceded by the term “about”):

| | | Injection | | |
|---|---|---|---|---|
| | | Pressure | | Material Brand |
| Material | Full Name | Range (PSI) | Company | Name |
| Pp | Polypropylene | 10000-15000 | RTP | RTP 100 series |
| | | | Imagineering | Polypropylene |
| | | | Plastics | |
| Nylon | | 10000-18000 | RTP | RTP 200 series Nylon |
| | | | Imagineering | |
| | | | Plastics | |
| ABS | Acrylonitrile | 8000-20000 | Marplex | Astalac ABS |
| | Butadiene Styrene | | | |
| PET | Polyester | 5800-14500 | Asia International | AIE PET 401F |
| Acetal | | 7000-17000 | API Kolon | Kocetal |
| Copolymer | | | | |
| PC | Polycarbonate | 10000-15000 | RTP | RTP 300 series |
| | | | Imagineering | Polycarbonate |
| | | | Plastics | |
| PS | Polystyrene | 10000-15000 | RTP | RTP 400 series |
| | | | Imagineering | |
| | | | Plastics | |
| SAN | Styrene | 10000-15000 | RTP | RTP 500 series |
| | Acrylonitrile | | Imagineering | |
| | | | Plastics | |
| PE | LDPE & HDPE | 10000-15000 | RTP | RTP 700 Series |
| | | | Imagineering | |
| | | | Plastics | |
| TPE | Thermoplastic | 10000-15000 | RTP | RTP 1500 series |
| | Elastomer | | Imagineering | |
| | | | Plastics | |
| PVDF | Polyvinylidene | 10000-15000 | RTP | RTP 3300 series |
| | Fluoride | | Imagineering | |
| | | | Plastics | |
| PTI | Polytrimethylene | 10000-15000 | RTP | RTP 4700 series |
| | Terephthalate | | Imagineering | |
| | | | Plastics | |
| PBT | Polybutylene | 10000-15000 | RTP | RTP 1000 series |
| | Terephthalate | | Imagineering | |
| | | | Plastics | |
| PLA | Polylactic Acid | 8000-15000 | RTP | RTP 2099 series |
| | | | Imagineering | |
| | | | Plastics | |

While more than one of the embodiments involves filling substantially the entire mold cavity with the shot comprising the molten thermoplastic material while maintaining the melt pressure of the shot comprising the molten thermoplastic material at a substantially constant pressure, specific thermoplastic materials benefit from the disclosure at different constant pressures. Specifically: PP, nylon, PC, PS, SAN, PE, TPE, PVDF, PTI, PBT, and PLA at a substantially constant pressure of less than about 69 MPa (about 10,000 psi); ABS at a substantially constant pressure of less than about 56 MPa (about 8,000 psi); PET at a substantially constant pressure of less than about 40 MPa (about 5,800 psi); Acetal copolymer at a substantially constant pressure of less than about 49 MPa (about 7,000 psi); plus poly(ethylene furanate) polyhydroxyalkanoate, polyethylene furanoate (aka PEF) at substantially constant pressure of less than about 69 MPa (about 10,000 psi), or about 56 MPa (about 8,000 psi), or about 49 MPa (about 7,000 psi) or about 42 MPa (about 6,000 psi), or about 40 MPa (about 5,800 psi).

Thermoplastic polymers generally have higher molecular weights, which correspond to higher viscosities and lower melt flow rates at a given temperature. In some cases, these lower melt flow rates can result in lower manufacturing output and can make large-scale commercial production prohibitive. To increase melt flow, the extruder temperature and/or pressure can be increased, but this often leads to uneven shear stress, inconsistent melt flow, bubble instability, sticking or slippage of materials, and/or non-uniform material strain throughout the extruder, resulting in poor quality extrudate having irregularities, deformations, and distortions that can even cause the extrudate to break upon exiting. Further, high temperatures can potentially burn the thermoplastic melt, and excessive pressures can breach the extruder's structural integrity, causing it to rupture, leak, or crack. Some or all of these problems can be problematic for the injection stage of the IBM process. Alternatively, viscosity modifying additives such as diluents can be included in the formulation to help increase melt flow, reduce viscosity, and/or even out the shear stress. Many of these additives tend to migrate to the polymer's surface, resulting in a bloom that can render the thermoplastic unacceptable for its intended use. For example, diluent migration can make the thermoinjection molded article look or feel greasy, contaminate other materials it contacts, interfere with adhesion, and/or make further processing such as heat sealing or surface printing problematic. The effect may depend upon the type and percent included in the composition. A non-migrating additive can also be used, such as HCO.

Additives may be included in the thermoplastic materials. For example, blend additives, including viscosity modifiers may be included. For example, the resin composition can include a mixture, blend or an intimate admixture of a wax having a melting point greater than about 25° C., comprising about 0.1% to about 50 wt % wax or about 5 wt % to about 40 wt % of the wax, based upon the total weight of the composition, or about 8 wt % to about 30 wt % of the wax, based upon the total weight of the composition., or about 10 wt % to about 20 wt % of the wax, based upon the total weight of the composition.

The wax may comprise a lipid, examples of which are a monoglyceride, diglyceride, triglyceride, fatty acid, fatty alcohol, esterified fatty acid, epoxidized lipid, maleated lipid, hydrogenated lipid, alkyd resin derived from a lipid, sucrose polyester, or combinations thereof. The wax may comprise a mineral wax examples of which are a linear alkane, a branched alkane, or combinations thereof. In other embodiments, the wax may comprise a wax which is selected from the group consisting of hydrogenated soy bean oil, partially hydrogenated soy bean oil, epoxidized soy bean oil, maleated soy bean oil, tristearin, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, 1,2-dipalmitolinolein, 1,2-distearo-olein, 1,3-distearo-olein, trimyristin, trilaurin, capric acid, caproic acid, caprylic acid, lauric acid, myristic acid, palmitic acid, stearic acid, and combinations thereof. The wax may comprise a wax is selected from the group consisting of a hydrogenated plant oil, a partially hydrogenated plant oil, an epoxidized plant oil, a maleated plant oil, and combinations thereof, wherein the plant oil may soy bean oil, corn oil, canola oil, palm kernel oil, or a combination thereof.

In other embodiments, oils or waxes may be selected from the group consisting of soy bean oil, epoxidized soy bean oil, maleated soy bean oil, corn oil, cottonseed oil, canola oil, beef tallow, castor oil, coconut oil, coconut seed oil, corn germ oil, fish oil, linseed oil, olive oil, oiticica oil, palm kernel oil, palm oil, palm seed oil, peanut oil, rapeseed oil, safflower oil, sperm oil, sunflower seed oil, tall oil, tung oil, whale oil, tristearin, triolein, tripalmitin, 1,2-dipalmitoolein, 1,3-dipalmitoolein, 1-palmito-3-stearo-2-olein, 1-palmito-2-stearo-3-olein, 2-palmito-1-stearo-3-olein, trilinolein, 1,2-dipalmitolinolein, 1-palmito-dilinolein, 1-stearo-dilinolein, 1,2-diacetopalmitin, 1,2-distearo-olein, 1,3-distearo-olein, trimyristin, trilaurin, capric acid, caproic acid, caprylic acid, lauric acid, lauroleic acid, linoleic acid, linolenic acid, myristic acid, myristoleic acid, oleic acid, palmitic acid, palmitoleic acid, stearic acid, and combinations thereof.

The wax or oil may be dispersed within the thermoplastic polymer such that the wax or oil has a droplet size of less than about 10 μm within the thermoplastic polymer or wherein the droplet size is less than about5 μm or wherein the droplet size is less than about 1 μm, or wherein the droplet size is less than about 500 nm

The composition may further comprise an additive, wherein the additive is wax or oil soluble or wax or oil dispersible. The additive may be a perfume, dye, pigment, surfactant, nanoparticle, antistatic agent, filler, nucleating agent, or combination thereof. These additives may be included even if a wax or oil is not incorporated into the composition. The wax or oil may be a renewable or sustainable material.

For example, the resin composition can include a mixture, blend or an intimate admixture of a thermoplastic starch having a melting point greater than about 25° C., comprising about 0.1% to about 90 wt % TPS or wax or about 10 wt % to about 80 wt % of the thermoplastic starch, based upon the total weight of the composition, or about 20 wt % to about 40 wt %. The thermoplastic starch may comprise starch or a starch derivative and a plasticizer. The plasticizer may comprise a polyol wherein the polyol is selected from the group consisting of mannitol, sorbitol, glycerin, and combinations thereof. In another embodiment, the plasticizer may be selected from the group consisting of glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5-hexanediol, 1,2,6-hexanetriol, 1,3,5-hexanetriol, neopentyl glycol, trimethylolpropane, pentaerythritol, sorbitol, glycerol ethoxylate, tridecyl adipate, isodecyl benzoate, tributyl citrate, tributyl phosphate, dimethyl sebacate, urea, pentaerythritol ethoxylate, sorbitol acetate, pentaerythritol acetate, ethylenebisformamide, sorbitol diacetate, sorbitol monoethoxylate, sorbitol diethoxylate, sorbitol hexaethoxylate, sorbitol dipropoxylate, aminosorbitol, trihydroxymethylaminomethane, glucose/PEG, a reaction product of ethylene oxide with glucose, trimethylolpropane monoethoxylate, mannitol monoacetate, mannitol monoethoxylate, butyl glucoside, glucose monoethoxylate, α-methyl glucoside, carboxymethylsorbitol sodium salt, sodium lactate, polyglycerol monoethoxylate, erythriol, arabitol, adonitol, xylitol, mannitol, iditol, galactitol, allitol, malitol, formaide, N-methylformamide, dimethyl sulfoxide, an alkylamide, a polyglycerol having 2 to 10 repeating units, and combinations thereof.

The starch or starch derivative may be selected from the group consisting of starch, hydroxyethyl starch, hydroxypropyl starch, carboxymethylated starch, starch phosphate, starch acetate, a cationic starch, (2-hydroxy-3-trimethyl(ammoniumpropyl) starch chloride, a starch modified by acid, base, or enzyme hydrolysis, a starch modified by oxidation, and combinations thereof.

Hydrogenated castor oil (also called castor wax) is a triacylglycerol prepared from castor oil, a product of the castor bean, through controlled hydrogenation. HCO is characterized by poor insolubility in most materials, very narrow melting range, lubricity, and excellent pigment and dye dispersibility. Because it is plant-based, HCO is a 100% bio-based and recyclable material. A suitable commercially available grade of HCO is “HYDROGENATED CASTOR OIL” available from Alnoroil Company, Inc. (Valley Stream, N.Y.). The principle constituent of HCO is 12-hydroxystearin. HCO is unique among fatty materials, as it primarily consists of 18-carbon fatty acid chains that each have a secondary hydroxyl group. While other waxes are prone to migrating to the thermoplastic's surface, HCO is unique because it does not. While not wishing to be limited by theory, it is believed that HCO is non-migrating because each molecule contains multiple (typically 3) hydroxyl (—OH) groups, enabling strong intermolecular hydrogen bonding between HCO molecules. A hydrogen bond is a directional electrostatic attraction involving a hydrogen atom and an electronegative atom such as an oxygen, nitrogen, or fluorine. In an —OH group, the oxygen attracts the bonding electrons more than the attached hydrogen does creating a dipole with the oxygen having a partial negative charge and the hydrogen a partial positive charge. Two —OH groups can thus be Coulombically attracted to one another, with the positive end of one interacting with the negative end of the other. In the case of HCO, a hydrogen of the —OH group of any particular fatty acid chain can interact with another —OH group on a different molecule to form an intermolecular hydrogen bond. Because HCO has multiple hydroxyl groups, multiple intermolecular associations are possible creating an entangled “supramolecular” structure with higher cohesive forces than other lower molecular weight lipids. While stronger than other non-covalent bonding, this form of intermolecular association can still be readily broken, thus preserving the thermoplastic nature of the composition. The composition can comprise, based upon the total weight of the composition, from about 5 wt % to about 50 wt % HCO, or from about 10 to about 50%, or from about 15 to about 50%, or from about 20 to about 50%, or from about 30 to about 50% HCO. The HCO contemplated for use herein has a melting point greater than about 65° C.

The HCO can be dispersed within the thermoplastic polymer such that the HCO has a droplet size of less than about 10 μm, less than about 5 μm, less than about 1 μm, or less than about 500 nm within the thermoplastic polymer. As used herein, the HCO and the polymer form an “intimate admixture” when the HCO has a droplet size less than about 10 μm within the thermoplastic polymer. The analytical method for determining droplet size is set forth herein.

If one desires to determine the percentage of HCO present in an unknown polymer-HCO composition (e.g., in a product made by a third party), the amount of HCO can be determined via a gravimetric weight loss method. The solidified mixture is broken apart to produce a mixture of particles with the narrowest dimension no greater than 1mm (i e the smallest dimension can be no larger than 1mm), the mixture is weighed, and then placed into acetone at a ratio of 1 g of mixture per 100g of acetone using a refluxing flask system. The acetone and pulverized mixture is heated at 60° C. for 20 hours. The solid sample is removed and air dried for 60 minutes and a final weight determined The equation for calculating the weight percent HCO is:

$$weight \% HCO = \frac{[ initial weight of mixture - final weight of mixture ]}{[ initial weight of mixture ]} \times 100 \%$$

Other waxes or oils can optionally be included such as hydrogenated soy bean oil, partially hydrogenated soy bean oil, partially hydrogenated palm kernel oil, and combinations thereof. Inedible waxes from Jatropha and rapeseed oil can also be used. Furthermore, optional waxes can be selected from the group consisting of a hydrogenated plant oil, a partially hydrogenated plant oil, an epoxidized plant oil, a maleated plant oil, and combinations thereof. Specific examples of such plant oils include soy bean oil, corn oil, canola oil, and palm kernel oil.

As described in detail above, embodiments of the disclosed substantially constant low injection pressure molding method and device can achieve one or more advantages over conventional high variable pressure injection molding processes. For example, embodiments include a more cost effective and efficient process that eliminates the need to balance the pre-injection pressures of the mold cavity and the thermoplastic materials, a process that allows for use of atmospheric mold cavity pressures and, thus, simplified mold structures that eliminate the necessity of pressurizing means, the ability to use lower hardness, high thermal conductivity mold cavity materials that are more cost effective and easier to machine, a more robust processing method that is less sensitive to variations in the temperature, viscosity, and other material properties of the thermoplastic material, and the ability to produce quality injection molded parts at substantially constant pressures without premature hardening of the thermoplastic material in the mold cavity and without the need to heat or maintain constant temperatures in the mold cavity.

The disclosed substantially constant pressure injection molding machines advantageously reduce total cycle time for the molding process while increasing part quality. Moreover, the disclosed substantially constant pressure injection molding machines may employ, in some embodiments, electric presses, which are generally more energy efficient and require less maintenance than hydraulic presses. Additionally, the disclosed substantially constant pressure injection molding machines are capable of employing more flexible support structures and more adaptable delivery structures, such as wider platen widths, increased tie bar spacing, elimination of tie bars, lighter weight construction to facilitate faster movements, and non-naturally balanced feed systems. Thus, the disclosed substantially constant pressure injection molding machines may be modified to fit delivery needs and are more easily customizable for particular molded parts.

Additionally, the disclosed substantially constant pressure injection molding machines and methods allow the molds to be made from softer materials (e.g., materials having a Rc of less than about 30), which may have higher thermal conductivities (e.g., thermal conductivities greater than about 20 BTU/HR FT ° F.), which leads to molds with improved cooling capabilities and more uniform cooling. Because of the improved cooling capabilities, the disclosed substantially constant low injection pressure molds may include simplified cooling systems. Generally speaking, the simplified cooling systems include fewer cooling channels and the cooling channels that are included may be straighter, having fewer machining axes. One example of an injection mold having a simplified cooling system is disclosed in U.S. Patent Application No. 61/602,781, filed Feb. 24, 2012, which is hereby incorporated by reference herein.

The lower injection pressures of the substantially constant low injection pressure molding machines allow molds made of these softer materials to extract 1 million or more molding cycles, which would not be possible in conventional high variable pressure injection molding machines as these materials would fail before 1 million molding cycles in a high pressure injection molding machine.

It is noted that the terms “substantially,” “about,” and “approximately,” unless otherwise specified, may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Unless otherwise defined herein, the terms “substantially,” “about,” and “approximately” mean the quantitative comparison, value, measurement, or other representation may fall within 20% of the stated reference.

It should now be apparent that the various embodiments of the products illustrated and described herein may be produced by a low, substantially constant pressure molding process. While particular reference has been made herein to products for containing consumer goods or consumer goods products themselves, it should be apparent that the molding method discussed herein may be suitable for use in conjunction with products for use in the consumer goods industry, the food service industry, the transportation industry, the medical industry, the toy industry, and the like. Moreover, one skilled in the art will recognize the teachings disclosed herein may be used in the construction of stack molds, multiple material molds including rotational and core back molds, in combination with in-mold decoration, insert molding, in mold assembly, and the like.

All documents cited in the Detailed Description of the disclosure are, in relevant part, incorporated herein by reference; the citation of any document is not to be construed as an admission that it is prior art with respect to the present disclosure. To the extent that any meaning or definition of a term in this written document conflicts with any meaning or definition of the term in a document incorporated by reference, the meaning or definition assigned to the term in this written document shall govern.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for injection molding overmolded articles comprising:
heating thermoplastic material to a predetermined temperature in an injection molding apparatus, wherein:
the injection molding apparatus comprises a mold, a plastic melt injection system, a sensor, and a controller;
the mold comprises a mold cavity;
the plastic melt injection system comprises a melt holder and an injection element; and
the injection molding apparatus has a useful life of more than 1 million and less than twenty million injection molding cycles;
positioning a pre-manufactured article in the mold cavity;
advancing heated thermoplastic material from the melt holder of the injection molding apparatus into the mold cavity using the injection element;
determining a melt pressure of the heated thermoplastic material as the heated thermoplastic material is advanced into the mold cavity using the sensor;
sending a signal from the sensor to the controller, the signal indicating the melt pressure of the heated thermoplastic material;
maintaining a substantially constant melt pressure of the thermoplastic material entering the mold cavity using the controller and the plastic melt injection system, wherein the melt pressure in the proximity of the injection element is from about 2 MPa (about 400 pounds per square inch) to about 69 MPa (about 10,000 pounds per square inch); and
substantially filling the mold cavity with thermoplastic material such that the pre-manufactured article is in contact with the thermoplastic material.

2. The method of claim 1, further comprising reducing the temperature of thermoplastic material such that the thermoplastic material substantially freezes to form an overmolded article; and
removing the overmolded article from the mold cavity, thereby completing one overmolded injection molding cycle.

3. The method of claim 1, wherein a maximum melt pressure of the thermoplastic material entering the mold cavity is within about 30% of a minimum melt pressure of the thermoplastic material entering the at least two mold cavities, such that the melt pressure is substantially constant.

4. The method of claim 1, wherein:
the thermoplastic material has a manufacturer's recommended injection temperature range; and
the predetermined temperature is less than the manufacturer's lowest recommended injection temperature.

5. The method of claim 4, wherein the predetermined temperature is at least about 40 degrees Celsius less than the manufacturer's lowest recommended injection temperature.

6. The method of claim 4, wherein the predetermined temperature is at least about 50 degrees Celsius less than the manufacturer's lowest recommended injection temperature.

7. The method of claim 1, wherein:
the thermoplastic material has a manufacturer's recommended injection pressure range; and
the melt pressure of the thermoplastic material entering the mold cavity is less than the lowest manufacturer's recommended injection pressure.

8. The method of claim 1, wherein the predetermined temperature the thermoplastic material is heated to is at least about 30 degrees Celsius less than the heat deflection temperature if any component of the pre-manufactured article.

9. The method of claim 1, wherein:
the pre-manufactured article comprises a temperature sensitive component, such that the pre-manufactured article experiences plastic or elastic deformation at a pre-manufactured article deformation temperature and
the predetermined temperature is less than the pre-manufactured article deformation temperature.

10. The method of claim 9, wherein the pre-manufactured article is selected from the group consisting of an electronic component, a soldered component, a component comprising fluid, a component comprising ink, a component comprising combustible material with a flash point below the predetermined temperature, and a component with a melt temperature or deformation temperature below the predetermined temperature wherein the component has a thermal mass substantially less than a thermal mass of the thermoplastic material.

11. The method of claim 1, wherein:
the pre-manufactured article comprises a shear pressure sensitive component, such that the pre-manufactured article experiences deformation at a pre-manufactured article upper shear pressure limit; and
the thermoplastic material is injected at a melt pressure that produces a shear pressure inside the mold cavity between the thermoplastic material and the pre-manufactured article of less than the pre-manufactured article upper shear pressure limit.

12. The method of claim 10, wherein the pre-manufactured article is selected from the group consisting of a label, an ornament, an indicator, a barrier, a gripping element, a textured element, and a tactile element.

13. The method of claim 1, wherein:
the pre-manufactured article comprises an injection pressure sensitive component, such that the pre-manufactured article experiences deformation at a pre-manufactured article maximum injection pressure; and
the melt pressure of the thermoplastic material entering the mold cavity is less than the pre-manufactured article maximum injection pressure.

14. The method of claim 13, wherein the pre-manufactured article is selected from the group consisting of a bottle, a container, a handle, a decoration, an ornament, a float, a bead, a tool, and a utensil.

15. The method of claim 1, wherein the pre-manufactured article comprises at least one of:
metal screws, magnets, electronic subassemblies, Radio Frequency Identification (RFID) tags, an electronic component, a soldered component, a component comprising an article fluid, a component comprising ink, a component comprising combustible material with a flash point below the predetermined temperature, a ceramic article, a hollow or partially hollow article, a medical device component, brush bristles, a mirror, a sponge, a rubber product, a lead-based solder, a lead free solder, a light emitting diode, a battery, cell, a resistor, a capacitor, an inductor, a microcontroller, an operational amplifier, electronic device, a binary or ternary Eutectic alloy, a label, an ornament, an indicator, a barrier, a gripping element, a textured element, a tactile element, a bottle, a container, a handle, a decoration, an ornament, a float, a bead, a tool, or a utensil.

16. The method of claim 1, wherein the pre-manufactured article comprises a decorated label having a printed side, the printed side facing a wall of the mold cavity during advancing of the heated thermoplastic material into the mold cavity.

17. The method of claim 1, further comprising mixing an aesthetic or functional additive with the thermoplastic material prior to advancing the thermoplastic material from the melt holder of the injection molding apparatus into the mold cavity;
wherein the additive comprises one of a fragrance, a color, a pearlescent agent, an anti-bacterial agent, an ultraviolet light barrier, a fluorescent or phosphorescent agent, a thermochromic material, a feel agent or a slip agent.

18. The method of claim 1, wherein the pre-manufactured article is an injection molded article.
